(19) United States
(12) Patent Application Publication
(10) Pub. No.: US 2021/0026904 A1
(43) Pub. Date: Jan. 28, 2021

(54) MECHANISMS FOR SERVICE LAYER RESOURCE RANKING AND ENHANCED RESOURCE DISCOVERY

(71) Applicant: CONVIDA WIRELESS, LLC, Wilmington, DE (US)

(72) Inventors: Quang LY, North Wales, PA (US); Xu LI, Plainsboro, NJ (US); Chonggang WANG, Princeton, NJ (US); Dale N. SEED, Allentown, PA (US); Zhuo CHEN, Claymont, DE (US); Lu LIU, Conshohocken, PA (US)

(21) Appl. No.: 16/982,199

(22) PCT Filed: Apr. 5, 2019
(86) PCT No.: PCT/US2019/026007

§ 371 Date: Sep. 18, 2020

Related U.S. Application Data
(60) Provisional application No. 62/653,671, filed on Apr. 6, 2018.

(51) Int. Cl. G06F 16/9532; G06F 16/951

(52) U.S. Cl. CPC G06F 16/9532; G06F 16/951

(57) ABSTRACT

A ranking service implemented at a service layer may be configured to provide mechanisms for ranking resources through service layer contexts called ranking events. The ranking service may enable the service layer to augment internally generated rankings, provide resource owners the ability to specify the targeted audience for their resources, and provide the ability for users to specify indications of ranking types that may be available to customize resource discovery results.

### BACKGROUND

The emergence of the Internet has revolutionized the way individuals and businesses communicate with each other. Email offers a faster way for people to communicate at a time that is convenient for both the sender and the recipient. Multi-national corporations may take advantage of the more efficient means of communications for teams across the globe to communicate with each other. Web sites allow businesses to operate at all hours of a day to enable global ecommerce. In effect, the Internet has made it convenient to communicate and do business globally.

At its core, the Internet is a communications system where computer networks are connected to offer users access to information available on those networks. Thus, users worldwide have a means to access information regardless of the location of the data or the time of day. Within each network, websites were built to expose the data to users—some for ecommerce, some for news reporting, and some for entertainment among the vast information that websites provide. Networks were built and connected to the Internet at breakneck speed and the resulting networks of networks was aptly referred to as the “World Wide Web.”

With the globalization and the abundance of information available on the Internet, search engines were created to offer users a singular point of access to find the desired information. The search engines were built upon web crawlers that scan the Internet to collect the available websites and the information those websites provide. Keywords and content were extracted from the websites and indexed in data centers worldwide to provide quick access for generating search results. Algorithms were created to provide search results that were relevant to search queries and the most popular websites were displayed at the top of the search results. In effect, search engines provide a ranking of websites based on their own proprietary criteria of what is popular.

### SUMMARY

Methods and systems are disclosed for ranking service layer resources. A ranking service implemented at a service layer may be configured to provide mechanisms for ranking resources through service layer contexts called ranking events. The ranking service may further be configured to enable the service layer to augment internally generated rankings, provide resource owners the ability to specify the targeted audience for their resources, and provide the ability for users to specify indications of ranking types that may be available to customize resource discovery results.

A service layer may be provisioned with a Ranking Profile that provides the Rank Values used to rank resources. These values may be required by the Ranking Service to rank resources based on the different types of ranking events. There may be separate values for the same ranking event to account for whether the event indicates a positive or negative impact to the resource's popularity. For example, creating a subscription resource may indicate the resource is popular while deleting a subscription resource may imply the resource is less popular. The rank values may define the criteria that the local Ranking Service uses to rank resources. When rank values of various service layers are different, the Ranking Profile may allow each service layer to normalize remote service layer rankings against its internal rankings so the rankings are based on the same criteria and can be compared to each other. This allows the rankings provided by remote service layers to be used with rankings provided by the local service layer.

A service layer may be configured to proactively augment its ranking by performing communications with remote service layers to obtain rankings of resources on remote service layers. Service layers may perform remote resource discovery on behalf of users, for example, when there are not enough ranked resources found in the local service layer. The results from the remote resource discovery may be combined with the ranked results found locally. A service layer may augment the rankings of announced resources on remote service layers whenever there is a retargeting request to the original resource on the remote service layer. Further, the service layer may rank remote service layers based on interactions with the remote service layer over a period of time. A higher rank for a remote service layer may imply that the resources on that service layer are more popular than resources from other remote service layers. This ranking can then be factored into ranking the announced resources from remote service layers.

A Resource Ranking Preference (RRP) profile may be created to specify the scenarios for which a resource may have elevated rankings. The RRP may be specified when a device is deployed as part of a service subscription, during service layer registration, or created thereafter when the resource owner wants to target the resource for a particular audience. A RRP may contain the types of users or applications a resource is targeting, a timeframe when the resource may have elevated ranking potential (e.g., during work week, during weekends, etc.), the location where the discovery request was made, etc.

To use the features provided by the Ranking Service, users may be able to specify the ranking criteria used for sorting the resource discovery results. The criteria may be specified in the resource discovery request or in a Customize Sorting Profile. The service layer may use the criteria to sort the results according to the rank of the resources. The user may additionally or alternatively specify that the discovery result be customized for the user's needs based on configurations provided during registration and/or based on previous requests. The user may specify that only the best ranked resource be returned to a discovery request for cases in which the user does not want to parse through a list of ranked resources. This option is referred to as Best Ranked Resource Discovery and may be applicable when the requestor is a constrained device with limited resources and wants to simplify post processing of the discovery results. The Ranking Service may utilize information in RRP profiles in combination with resource ranks to find the best match to the user's query.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 shows a flow chart of an example service layer resource discovery method;

FIG. 2 shows an example overview of a service layer ranking service;

FIG. 3 shows a flow chart of an example method performed by the service layer ranking service;

FIG. 4 shows an example equation for calculating the total rank of a resource;

FIG. 5 shows examples of different types of service layer rankings;

FIG. 6 shows a flow chart of an example method for ranking service layer resources based on service layer resource discovery selection events;

FIG. 7 shows a flow chart of an example method for ranking service layer resources based on service layer resource accesses;

FIG. 8 shows a flow chart of an example method for ranking service layer resources based on service layer subscriptions and notification targets;

FIG. 9 shows a flow chart of an example method for ranking service layer resources based on service layer group fan-out responses;

FIG. 10 shows a flow chart of an example method for ranking service layer resources based on service layer announced resources;

FIG. 11 shows a flow chart of an example method for ranking service layer resources based on a most ranked list;

FIG. 12 shows a flow chart of an example method for remote service layer resource discovery;

FIG. 13 shows a flow chart of an example method for a ranking update procedure for retargeted access of announced resources;

FIG. 14 shows a flow chart of an example method for a ranking update procedure for direct access of original resources;

FIG. 15 shows a flow chart of an example method for remote service layer ranking weights and proactive weight adjustments;

FIG. 16 shows a flow chart of a procedure involving service layer user specified ranking criteria;

FIG. 17 shows a flow chart of an example method for service layer customized ranked discovery;

FIG. 18 shows a flow chart of an example method for service layer best ranked resource discovery;

FIG. 19 shows a flow chart of an example method for retrieving a most ranked list from a service layer;

FIG. 20 shows an example integration of a ranking service to OCF cloud native architecture;

FIG. 21 shows a flow chart of an example method for an OCF server endpoint registration to a resource directory;

FIG. 22 shows a flow chart of an example method for OCF resource discovery with the ranking service;

FIG. 23 shows an example user interface;

FIG. 24A shows an example system diagram of an example machine-to-machine (M2M) or Internet of Things (IoT) communication system in which one or more disclosed embodiments may be implemented;

FIG. 24B shows an example system diagram of an example architecture that may be used within the M2M/IoT communications system illustrated in FIG. 24A;

FIG. 24C shows an example system diagram of an example M2M/IoT terminal or gateway device that may be used within the communications system illustrated in FIG. 24A; and

FIG. 24D shows an example block diagram of an example computing system in which aspects of the communication system of FIG. 24A may be embodied.

### DETAILED DESCRIPTION OF ILLUSTRATIVE EMBODIMENTS

To provide rankings of relevance and popularity, search engines may employ Search Engine Optimization (SEO) techniques. These techniques operate on the main assumption that the more popular a website is, the more valuable information that web site contains. One common method to determine popularity is the detection of cross links within websites. Cross linking is the process of linking information between two websites and is typically used to reference websites with similar content. Another popular method is click throughs of web search results in which users select the link of a website that is of interest to them. Studies have shown that the higher ranked a website is in the search results, the better chance that a user will click through to access that website.

SEO is a science in itself. Each search engine provider has their own criteria for ranking websites and publishes guidelines to website developers for obtaining the highest rankings in their search results. Example criteria may include how feature rich the content is on the website, how descriptive the title is, whether the URL contains pertinent keywords, whether the site is designed for mobile devices, whether content is buried within rich media (Flash, JavaScript, Ajax, etc.) and links obstructed from crawlers, whether the website follows a certain structure, etc. These example guidelines define requirements that websites may need to meet to get the best possible ranking from the search engine. Thus, web search rankings not only depend on the search engine and the algorithms they use, but also on the way websites are created and the content they provide.

Even though SEO techniques have become fairly sophisticated, there are still certain limitations that search engine crawlers face. Web crawlers reference a robots.txt document on a website to map the contents of that website and enable the crawler to scan for all contents within the website. An improperly formatted robots.txt document may block the web crawler from accessing certain sections or even the entire website. Web crawlers may also have difficulties with poor web link structure if they can't understand them and may not be able to readily parse non-text contents such as images, videos, animations, etc. There may also be issues with online forms, duplicate pages, and broken links.

Similar to the way the Internet revolutionized how people communicate, the Internet of Things (IoT) will revolutionize the way people live. The IoT is an extension of the Internet by connecting normal everyday devices such as cars, appliances, televisions, security cameras, and all types of sensors together to automate and better the lives of its users. Once these devices are connected to the Internet, new applications can be created to link all these things together for more advanced applications.

The key enabling technology for the IoT is the Service Layer, which is a middleware software component residing at the application layer of the communications stack. Examples of Service Layer technologies include a oneM2M Common Services Entity (CSE), an IETF Resource Directory (RD), and an OCF Cloud Native architecture. This software component operates to provide various services available to users of the Service Layer, such as resource discovery, data repository, subscriptions and notifications, device and event management, etc. Interactions between users and devices or even between devices themselves are made possible through the Service Layer.

The proliferation of IoT devices may require the Service Layer to provide for search capabilities similar to those of web searches. For example, a user or application may first submit a resource discovery query that contains pertinent keywords to locate a resource that is of interest within the SL. The Service Layer may then perform a search within its database to locate all resources that match the criteria provided in the search query, and a resulting list of matching resources may be returned to the user or application.

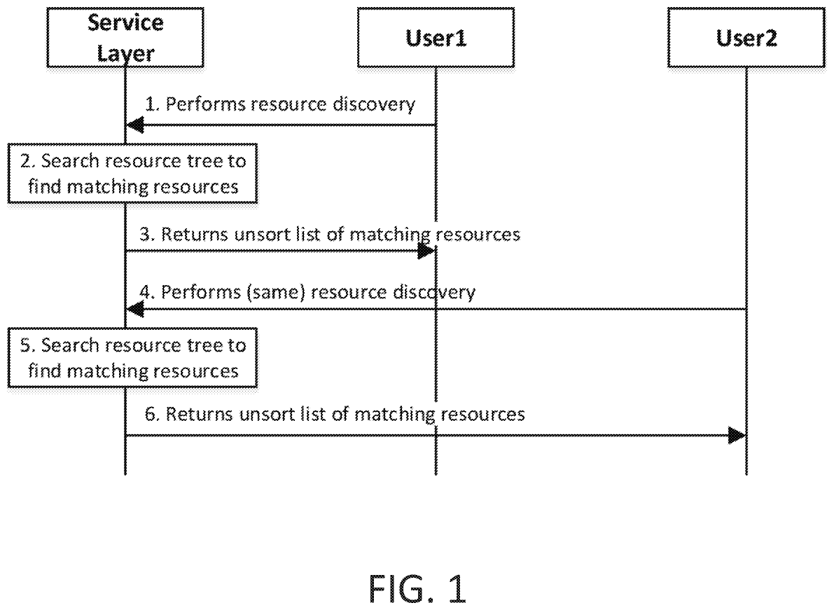

Current SL resource discovery provides users the ability to find resources hosted on the SL that match certain search criteria. However, unlike web searches, SL resource discovery lacks the ranking capabilities provided by search engines. The response returned to users may not be sorted in the order that would be beneficial to the user. Instead, the list may be provided in any order as long as each resource matches the search criteria. FIG. 1 shows an example flow chart of two users performing resource discovery on the service layer using the same search criteria (e.g., find all security cameras in the city). The results returned are the same for both users even though the users may have different needs due to being at different locations, in different industries, and for different purposes. For example, User1 may want to obtain traffic information from viewing the cameras while User2 may want to use the camera footage as part of a criminal investigation.

Existing SL resource discovery provides filter criteria for searching resources that are of interest to the user. Some criteria are used to find a resource of a particular type such as the oneM2M attributes “labels” and “resourceType.” Other criteria are used for comparing to resource meta-data such as “createdAfter,” “modifiedSince,” and “sizeAbove.” Yet other criteria are high level abstractions provided by a “semanticsFilter” and a “contentFilterSyntax.” All these criteria focus on quantifiable information about the resource but not on the popularity of the resource when compared to other resources in the SL. In other words, there are currently no mechanisms for users or resource owners to specify the ranking criteria applied to the resource discovery results.

Some work in applying SEO techniques to a CoRE Resource Directory exists in which the RD uses cross-linking information, knowledge of sleepy nodes, and the appearance of resource links in groups to help provide ranking information for resource queries and to also address quasi-load balancing issues. This work closely follows the SEO techniques from web technology to provide ranking based on open loop data where the RD is gathering information about resources and making a determination that may indicate the popularity of a resource. The work, however, does not address the use of closed loop feedback (i.e., actual resource accesses that reflects the real popularity of a resource).

In Service Layers, there are many instances of readily available contexts that can be used to provide for more effective ranking and customizations of resource discovery results. Users of a SL are required to be registered and context from the registration may be used to tailor the search results. In addition, since the SL also hosts the resources that appear in search results, the SL may also have context about the resources themselves from their registration information, the popularity of the resource as indicated by accesses by other users, and the freshness of the resources. The SL is therefore in position to combine contexts from both users and resource owners to rank and customize resource discovery results. This contrasts with the way search engines provide ranking information as the ranking criteria is based on a priori data cultivated from the contents of websites by web crawlers.

The Service Layers are also in a better position than web search engines to obtain context on what users do with the search results and can provide resource owners mechanisms to connect to a targeted audience. In web searches, click throughs provide some indication that users are interested in a particular web link. However, search engines are only able to “know” that the user retrieved the provided web links. There are no indications of what the user does with the information after it has retrieved the information as those actions (e.g., logging into a website) are performed on the websites pointed to by the web links. Search engines do not have access to what the user does after logging in to the website. Service Layers, on the other hand, have complete context of how the users utilize the discovery results, including the actions that are performed, from retrieving another resource to creating a new resource on the SL. These contexts are readily available to the SL but are not currently being taken advantage of.

Another subtle but important difference between SL and web technologies is the fact that SLs have context of the number of users who access a particular resource and can use that context to build a ranking as to the popularity of the resource. SLs either host or are aware of where resources are hosted while search engines do not have access to this type of information as they do not host websites that appear in their search results. Search engines use other indirect methods, such as examining for cross links, to make a determination as to the popularity of a website. These indirect methods limit a search engine's ability to make a direct correlation of popularity of a website based on actual usage. For example, a user may access a particular website directly by typing the website's URL, therefore bypassing the search engine altogether.

Another limitation of search engines is the inability to process online forms. For example, logins and any content contained behind the logins may be hidden from the search engine. This contrasts with SLs which handle both access control and security policies natively. This allows SLs to obtain additional contexts even if the communications are secured between entities.

All the aforementioned contexts that are available to Service Layers are part of normal SL operations and hence have limited overhead as it pertains to the ranking of resources. Search engines, on the other hand, employ web crawlers that navigate the Internet to provide updates to its ranking algorithms. Web crawling requires access to websites that are readily available but IoT devices may have sleep cycles and limited resources that makes crawling them difficult. Thus, search engines require active web crawling and certain overhead to provide ranking results.

Even though Service Layers have readily available contexts for ranking resources, those contexts are not currently being utilized. The overhead of providing such a ranking service is minimal when compared to the overhead required to provide search engine ranking and the benefits gained can help users better access SL resources. A new Ranking Service is disclosed herein to enable such functionalities. The Ranking Service may be comprised of:

Mechanisms for ranking SL resources using SL contexts. The mechanisms may comprise a Ranking Profile that is configured for a SL to provide ranking services. The Ranking Profile may comprise Rank Values for each of the Ranking Events that triggers an update to the rank of a resource. In addition, the Ranking Profile may be used to normalize resource rankings from remote SLs so the ranks can be compared together. Finally, the Ranking Service may also include customized “Most Ranked Lists” that users may find useful;

Proactive methods that a SL can perform to augment the rankings it provides for the resources it hosts. A method of performing remote SL resource discovery may be used when there are not enough ranked resources found in the local SL. In addition, ranking updates of announced resources may be made when retargeting accesses of announced resources or when directly accessing the original resource. This ranking update may include the normalization of the rank of the remote resource. Methods are disclosed in which a SL can rank the popularity of other SLs based on monitoring retargeting requests to those SLs. The SL ranking may reflect the popularity of resources hosted on remote SLs;

Mechanisms for resource owners to specify the preferences of the targeted audience their resource may be matched against. A Resource Ranking Preference (RRP) profile may be created to specify the scenarios for which a resource may have elevated rankings (e.g., based on the types of users or applications, based on a preferred time, based on resource discovery performed from a particular location, based on resource tiers, etc.) The RRP profile may be used in conjunction with the Customize Sorting Profile to offer enhanced resource discovery results to both end users and resource owners; and

A user indication for obtaining resource discovery results that are sorted according to user's needs. Definitions of Rank Criteria and Customize Sorting Profiles are provided for users to specify and customize resource discovery to get tailored results based on their sorting preferences. The Ranking Service may also use Resource Ranking Preference Profiles to match resources from resource owners to their targeted audience. When these mechanisms are combined together, users may request and receive the best ranked result to simplify parsing requirements. This is especially useful for constrained IoT devices without the capability to readily parse a list of results.

In order to provide resource rankings and customized ranked discovery results, the Service Layer may be enhanced with the introduction of a Ranking Service. The service may include the following functionalities: providing mechanisms to rank resources through SL contexts called ranking events, adding proactive methods that the SL may use to augment internally generated rankings, providing resource owners the ability to specify the targeted audience for their resources, and providing the ability for users to specify indications of ranking types that may be available to customize resource discovery results. Note that the Ranking Service discussed herein may operate as a separate, standalone service located remotely from or co-located with the Service Layer. Additionally or alternatively, it may also be integrated together with the Service Layer.

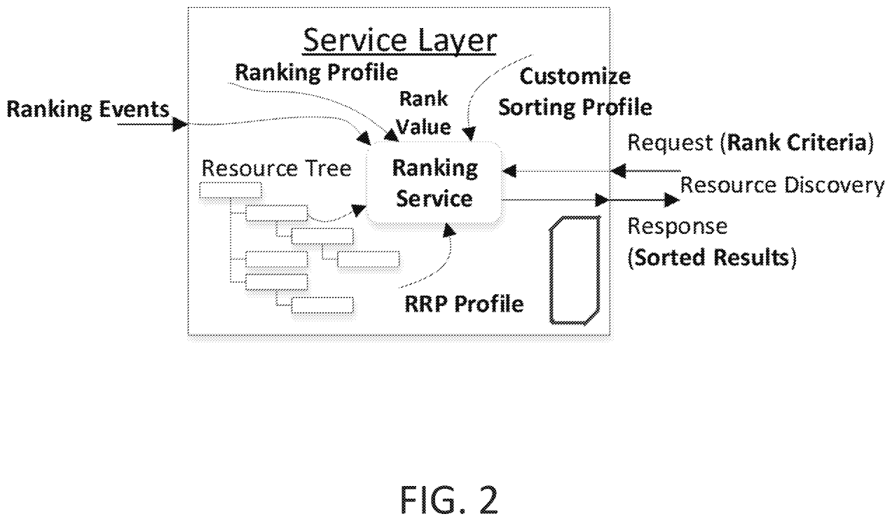

FIG. 2 shows an example Ranking Service integrated within a Service Layer and illustrates the different components utilized by the Ranking Service. The bold text shown in FIG. 2 highlights example mechanisms of the Ranking Service. The Ranking Service may provide rankings for resources managed by the Service Layer and may sort the results of a resource discovery request according to user provided rank criteria. The components of the Ranking Service that achieve this functionality may comprise one or more of the following:

Ranking Profile: A profile that provides the Rank Value that is used to update the rank of a SL resource. The profile may define the association between Ranking Events and the Rank Value used for the computation of a resource rank. A ranking factor may be used to normalize resource rankings between different ranking profiles (e.g., between service layers) and a profile ID may be used to identify each ranking profile. Note that multiple ranking profiles may exist within a SL to provide different rank values to serve different needs (e.g., for different industry segments);

Customize Sorting Profile: SL users or applications may specify their sorting preferences for resource discovery results in the Customize Sorting Profile. Within the profile, users may specify the rank criteria to use for sorting discovery results, the types of resources for performing resource discovery, the minimum rank to include in discovery results, etc.;

Resource Ranking Preference (RRP) Profile: Resource owners may define the targeted audience for their resources and specify the scenarios in which to elevate the rankings of those resources. The RRP profile may be used in conjunction with the Customize Sorting Profile to offer enhanced resource discovery for both users and resource owners;

Ranking Events: A SL event that triggers the update of the rank of a resource. Many types of SL events may exist (as described further below). Each Ranking Event may have corresponding Rank Values for updating the rank of a resource as specified in the Ranking Profile; and

Rank Criteria: A user specified criteria included in a resource discovery request to indicate how the results should be sorted in the response.

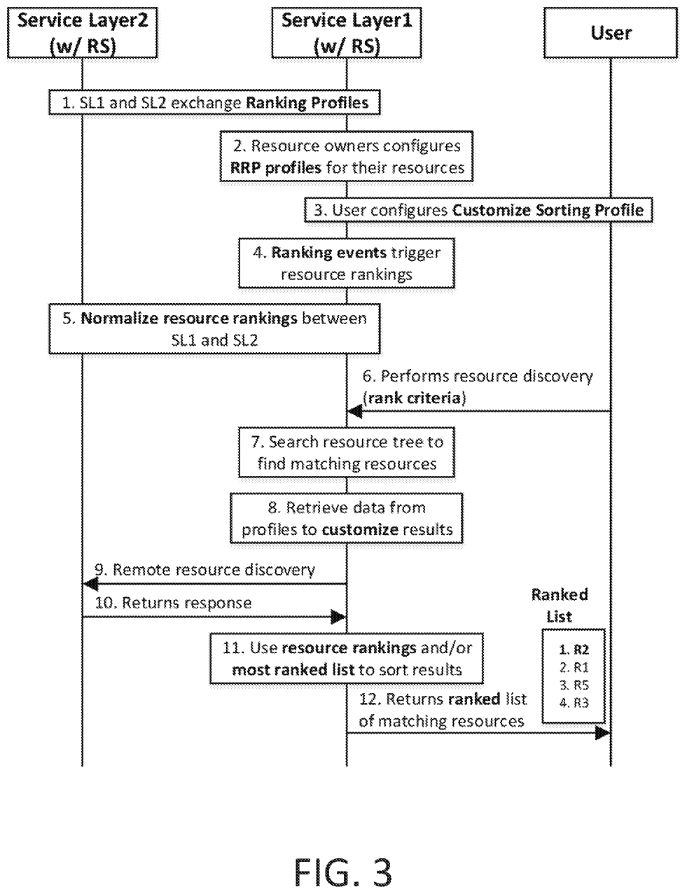

FIG. 3 shows the example concepts introduced in FIG. 2 applied within a SL system. The call flow of FIG. 3 demonstrates an example of how the overall ranking process operates and includes the interactions among SLs, users, and the Ranking Service (which is shown integrated within the SLs). The bold text highlights the example features and operations of the Ranking Service.

The following describes in detail the steps of FIG. 3. Each step, where highlighted in FIG. 3, refers to a component of the Ranking Service that will be described in detail hereafter:

At step 1, SL1 and SL2 exchange Ranking Profiles to allow each SL to normalize the resource ranks that may be shared between the SLs.

At step 2, resource owners may configure Resource Ranking Preference (RRP) profiles to indicate the targeted audience for the resources they own.

At step 3, users may configure Customize Sorting Profiles to indicate the types of resources and/or sorting preferences for tailoring resource discovery results to their needs.

At step 4, through SL contexts, which are normal SL operations, ranking events are detected that trigger resource ranking updates.

At step 5, through SL to SL interactions, resource rankings may be shared and normalized between SL1 and SL2. When three or more SLs interact, each SL may have the capability to rank remote SLs, which is used to show the level of popularity of resources on each of the remote SLs.

At step 6, a user performs resource discovery and may provide ranking criteria in the request to indicate the sorting preference of the results. Alternatively, a Customize Sorting Profile may be used if one was provided in step 3.

At step 7, SL1 performs discovery of its resource tree to find matching results to the user's query.

At step 8, SL1 may retrieve information from a Customize Sorting Profile if one was provided in step 3.

At step 9, SL1 may proactively perform remote resource discovery on SL2 to find more resources for the user.

At step 10, SL2 returns a response of matching resources with the associated rank of each resource.

At step 11, SL1 generates a sorted list of ranked resources based on information from the Ranking Criteria, the Customize Sorting Profile, and/or the Resource Ranking Preference profile. The results may be tailored to both the user's and resource owner's needs. If remote resource discovery was performed and SL2 provided a response of matching resources and their ranks, SL1 may normalize resources from SL2 according to SL2's Ranking Profile.

At step 12, SL1 returns the ranked list to the user.

Note that the rankings discussed herein may refer to the ranking of a SL resource or a service layer entity. In addition, the term “users” may refer to human users, cloud applications, device applications, other service layers, etc.

Mechanisms for ranking SL resources to enhance SL resource discovery are disclosed. The SL may have an abundance of contexts it can use to generate rankings for resources it hosts. These contexts may be obtained during normal SL operations, thus minimizing the overhead of the Ranking Service. The contexts may be based on actions taken by users of the Service Layer and as a result, the ranking may not be intrusive to normal SL operations. Users may not even be aware of such ranking until it is used for resource discovery or for retrieving a resource's rank. However, users may benefit by receiving resource discovery results with better appropriateness.

Within a Service Layer, a resource's rank may be comprised of SL events, herein referred to as Ranking Events, such as:

resource discovery selection events;

CRUD accesses to resources;

the number of subscriptions and notification targets a resource has;

whether an announced resource exists; and

the responses to group fan-out operations.

These ranking events may contribute to the “popularity” of a resource due to the fact it is being accessed by users of the Service Layer. In addition, the SL may also maintain aggregated ranking lists based on the cumulative rankings of a weighted sum of the aforementioned rankings. These aggregated ranking lists are termed “Most Ranked” lists that may be based on some quantifiable criteria, as discussed further herein. The Ranking Service may also use the resource rankings in an inverse manner (e.g. to promote less popular resources).

Two types of ranking may be offered by the Ranking Service: local SL resource ranking and remote SL ranking. The local resource ranks may be determined by normal SL events made to the resource, such as whether the operation is a Create, Retrieve, Update, or Delete operation. The rank can be updated depending on the operation and the rank can be maintained for certain resources while not for others. For example, ranking of resources may be made on a granular level where individual sensors that each belong to the same device are ranked. Additionally or alternatively, the ranking may be made on a more general level where only devices are ranked and the operations on the individual sensors contribute to the device's rank.

When ranking of a resource is based on a ranking event, a Rank Value may be tailored to reflect the underlying event that triggered the ranking calculation. Some ranking events may carry a higher rank value than other events, and this value may be used to update the rank of the resource. These rank values can be provisioned to the SL in a Ranking Profile and may even be dynamically changed by a SL administrator. The rank value may then be used to update the rank of the resource. For example, the following ranking events may be configured with the indicated rank value: resource discovery selection=3, retrieve=1, update=2, create=3, delete=4, sub/notif=5, etc.

Each SL may be provisioned with a Ranking Profile that provides the Rank Values used to rank resources. These values may be required by the Ranking Service to rank resources based on the different types of ranking events. There may be separate values for the same ranking event to account for whether the event indicates a positive or negative impact to the resource's popularity. For example, creating a subscription resource may indicate the resource is popular while deleting a subscription resource may imply the resource is less popular. The rank values may define the criteria that the local Ranking Service uses to rank resources. When rank values of various SLs are different, the Ranking Profile may allow each SL to normalize remote SL's rankings against its internal rankings so the rankings are based on the same criteria and can be compared to each other. A ranking factor may be calculated or provided to scale the resource ranks of remote SLs for comparison to resource rankings of the local SL. This ranking factor may be based on differences between the rank values of the two Ranking Profiles. For example, SL1 may rank resources higher for resource discovery selection events while SL2 may prioritize resource retrieve events. When SL2 uses resource rankings from SL1, those rankings may be scaled by a ranking factor to account for differences in how the resource rankings were computed. This mechanism allows the rankings provided by remote SLs to be used with rankings provided by the local SL.

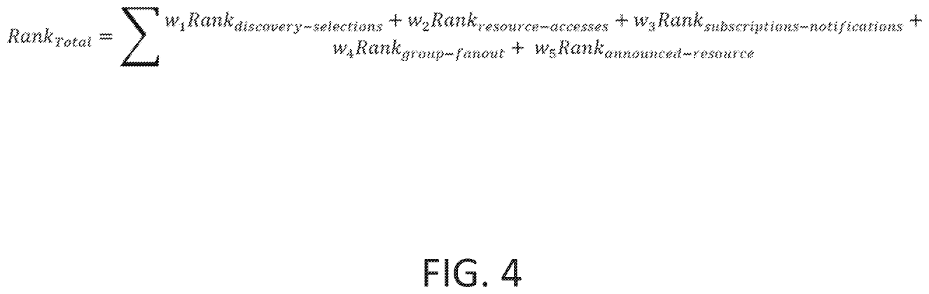

The total rank of a resource can therefore be the sum of all the individual weighted ranks (or average of the weighted sum) that the Ranking Service provides. Each of the aforementioned ranking events may be computed individually and weighted according to the importance of each category relative to each other. The weights (w, where i=1 to N) themselves may be adjusted by SL administrators to change the ranking priorities of the different ranking events. An example equation for determining the total rank of a resource is shown in FIG. 4.

By adjusting the weights of each ranking event component, the SL may then provide custom ranking lists to its users. For example, if resource discovery selection events are more important, then the corresponding weight may be increased and may have a higher contribution to the overall rank of the resource. Therefore, different customizations may be made based on the underlying criteria of interest and the resulting ranking may be offered as a “Most Ranked List” to users. For example, a “Most Subscribed” list may be created by setting w3 in FIGS. 4 to 1 and zeroing all other weights. Other “Most Ranked” lists may be created in a similar manner.

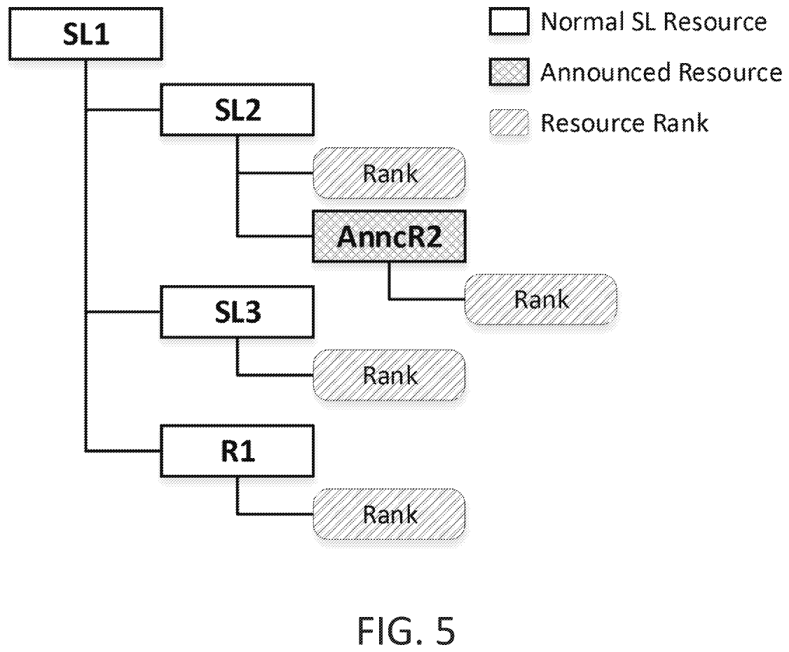

In addition to SLs ranking local resources, the local SL may also be in position to rank remote SLs that it communicates with. These remote SL rankings may be broader and may be used to rank remote SLs that provide services and resources to users of the local SL. The remote SL ranking may indicate the relative popularity of that SL's resources against the popularity of resources of other remote SLs. If the remote SL has announced resources on the local SL, then the local SL may obtain a resource ranking from the remote SL to augment the remote SL ranking. FIG. 5 shows an example of the rankings that a SL may maintain for both local and remote resources. SL2 and SL3 are resources associated with remote SLs of SL1, AnncR2 is an announced resource belonging to SL2, and R1 is a resource hosted locally in SL1. Each resource has their own resource rank.

Note that in the following examples where the SL updates a resource's rank based on the corresponding ranking events, the ranking update may only apply to user's requests who are not owners of the resource. For some ranking events, the SL may not update the rank of the resource if the request was made by the owner of the resource to prevent the owner from artificially inflating the rank of its own resource. Instead, the Service Layer may include the rank of the resource in the response to the owner's request. However, for other ranking events such as updating a resource, the SL may update the rank of the resource even though the resource owner is performing the operation since it is applicable to the ranking mechanism (e.g., the rank is included in a Most Recently Updated ranking list). The decision of whether to adjust the rank of a resource due to an operation by the owner may be specified in the Ranking Profile.

Resource ranking may be based on SL resource discovery selection events. A SL resource discovery selection event may be defined as the subsequent action(s) a user takes after receiving the resource discovery results. This is similar to a web click-through event except for the available actions that a user can take. In web click-throughs, the only option a user has is to retrieve the provided link of the search results. For a SL resource discovery selection event, however, the user may be able to perform not only retrieves but also updates, creates, and deletes of the resource or a child of the resource that is discovered. An update operation to a resource may result in numerous notifications being generated and potentially future retrieve requests as a result, whereas a retrieve of a resource may not cause any other SL event to occur; therefore, different operations have different impacts on the rank to be adjusted. In some cases, the action may involve a device management command. Due to this fact, the SL resource discovery selection event provides for more granular context of what users do with the search results and may impact the SL differently.

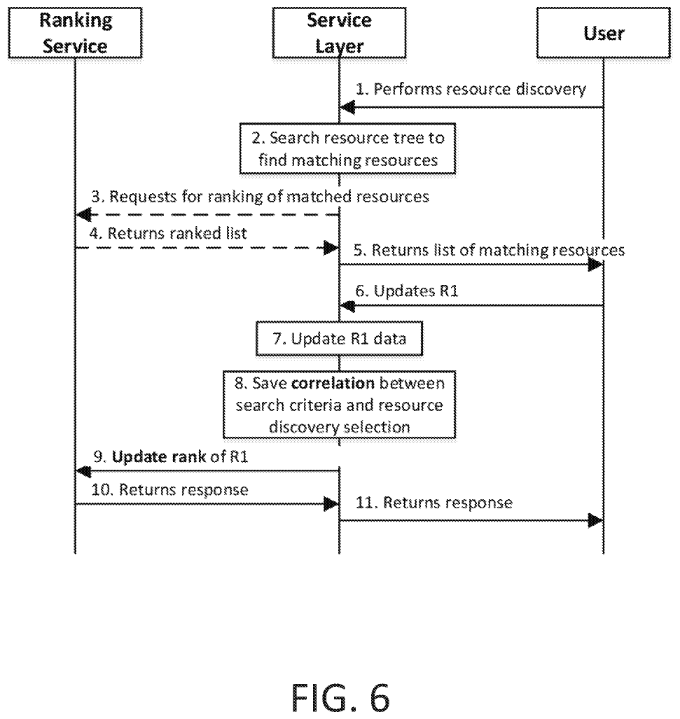

FIG. 6 shows a procedure of a SL resource discovery selection event occurring in step 6 when the user performs an update request in response to the information received in step 5. Note in the figure that the Ranking Service is remotely located from the Service Layer. The following describes in detail the steps of FIG. 6.

At step 1, a user performs resource discovery on the Service Layer.

At step 2, the Service Layer searches its resource tree to find matching resources.

At step 3, after finding matching resources, the Service Layer may optionally contact the Ranking Service to obtain a rank for each resource found. The Service Layer may specify a ranking criteria in the request to the Ranking Service to indicate how the list should be sorted. The criteria may be provided by the user or may be determined by the SL when performing a customized ranked discovery request, as described herein.

At step 4, the Ranking Service returns a ranked list of the resources provided by the Service Layer based on the sorting criteria (if one was provided).

At step 5, the Service Layer returns the ranked list to the user. If there were no sorting criteria specified by the user or by a SL configuration, then an unsorted list of results may be returned to the user. The SL resource discovery selection event does not depend on whether the results are sorted or not.

At step 6, the user selects one of the resources it may be interested in (e.g. R1) from the response received in step 5 and performs an operation on the resource. FIG. 6 shows the operation as an update but other operations such as create, retrieve, or delete may also be made. This request signifies that a SL resource discovery selection event has occurred since it was made based upon information provided by the response to a resource discovery request made in step 5.

At step 7, the Service Layer updates the data for resource R1 or performs the requested operation specified by step 6.

At step 8, the Service Layer records the request from step 6 as a SL resource discovery selection event and may save some correlation data between the search criteria specified in step 1 and the resulting operation performed in step 6. The correlation data may be saved and used for providing customized ranked discovery, described below.

At step 9, the Service Layer sends a request to update the rank of R1 by the rank value associated with a resource discovery selection event. The SL may also request to remove the rank value of a specific resource, for example, if the resource discovery selection event in step 6 was to delete a resource.

At step 10, the Ranking Service may return a response that includes the new rank of R1.

At step 11, the Service Layer updates the new rank of R1 and returns an appropriate response to the user.

Typically, a resource discovery selection event occurs shortly after a user has received the resource discovery results. However, there may be instances in which the resource discovery selection event does not occur immediately after the user receives the response to the resource discovery. These instances may be caused by connectivity issues or by resource intensive operations on the user's end, or it may be due to the fact that the user has selected a resource it did not find suitable for its needs and is selecting another resource. These instances may be referred to as delayed resource discovery selection events and may cause the Ranking Service to adjust the rankings of multiple resources. If multiple operations are made by the user, the first resource accessed may have its rank reduced since the user did not find it useful while the second resource accessed may have its rank increased.

Resource ranking may be based on accesses to SL resources. Once a user has discovered a resource it is interested in through resource discovery, the user may access the resource by reusing the discovered URI in the future. At this point, the user may not need to perform another resource discovery and hence, no resource discovery selection event occurs. However, having already found the URI of the resource in a previous discovery request, the user may continue to access the resource in the future. The fact that the user is still interested in the resource indicates that the resource is still useful, and this may warrant an increase to the rank of the resource. Once again, the value to update the rank of the resource may depend on the operation requested by the user and the associated rank value.

This type of event is unique to Service Layer technologies as it directly captures the user's continued interest in the resource long after it was initially discovered. Web technologies, on the other hand, do not have this capability as websites are potentially hosted separate from the search engine. Other users may also be interested in the same resource and the SL may be in position to rank the resource accordingly. These ranking events are organically occurring in the SL and therefore represent the true popularity of the resource and are not a derived popularity as calculated based on the presence of web links.

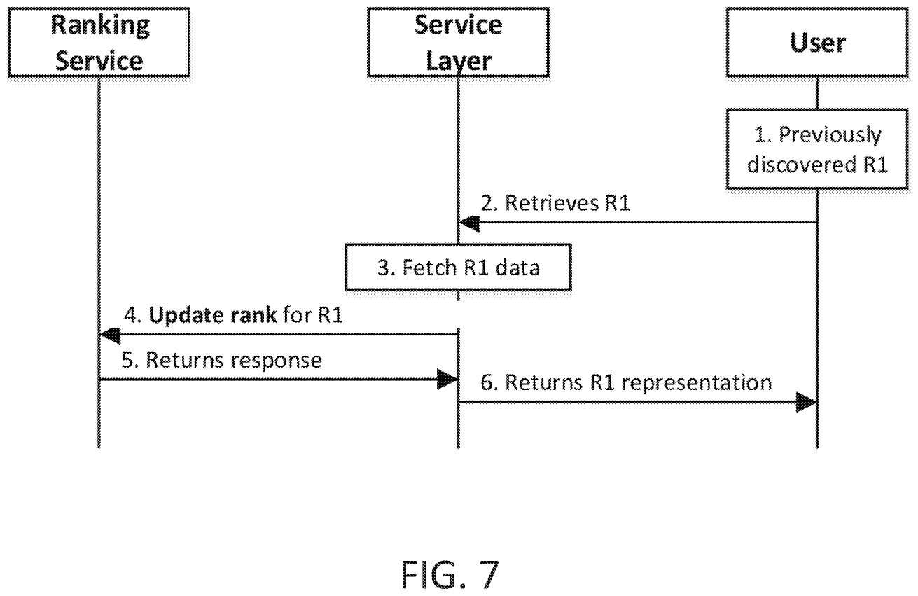

FIG. 7 shows an example procedure for ranking accesses to SL resources. The following describes in detail the steps of FIG. 7:

At step 1, a user had previously discovered the resource R1 and found it was useful, and a SL resource discovery selection event was triggered when the user updated R1's resource as shown in FIG. 6.

At step 2, some time later, the user wants to get an update for R1 and makes a request to retrieve R1. The fact the user is accessing the resource again in the future indicates that the resource is useful to the user. Note that FIG. 7 shows a retrieve operation but the request may also be a create, update, or delete request.

At step 3, the Service Layer fetches the data for resource R1.

At step 4, the Service Layer makes a request to the Ranking Service to update the rank for R1 as an indication of the popularity of the resource. The rank value provided may be obtained from the Ranking Profile that specifies values for different ranking events and their operations (e.g., operations in which child resources are created may have higher rank values than operations where data is retrieved). Additionally or alternatively, the SL may aggregate the updates to the rank of the resource at a later time to minimize communications overhead to the Ranking Service.

At step 5, the Ranking Service returns a response that includes the new rank of R1.

At step 6, the Service Layer updates the ranking for R1 and returns the representation of R1 to the user. Note that R1's representation may be returned right after step 3. In that case, the update to the resource rank may follow or be delayed if the rank update is aggregated at a later time.

Resource ranks may be decreased if a user deletes a child resource of the ranked resource. The removal of child resources may reduce the exposure of the parent resource from appearing in discovery results and hence, the rank may be reduced accordingly. The removal of a child resource by the SL due to expiration time may also reduce a parent resource's rank. Certain update operations may also trigger a reduced rank, such as an update to an attribute of a resource that indicates the resource is not available or a failure to respond to a request. The Ranking Profile of the SL may define how ranking events impact (e.g., whether to increase or decrease) the rank of resources to account for the popularity of the resource.

Resource ranking may be based on SL subscriptions and notification targets. Ranking resources may be performed whenever users request to create subscriptions for a resource. In these cases, users are indicating that the resource is of great importance such that they would like to be notified of changes to the resource. Example changes include an update to a resource, the creation of a new child resource, an update of a particular attribute, etc. Users may put limits and conditions that trigger the notification. Thus, the creation of subscription resources and the corresponding number of notification targets show that the resulting event is of great importance to the user and therefore, may be ranked highly when the events do occur.

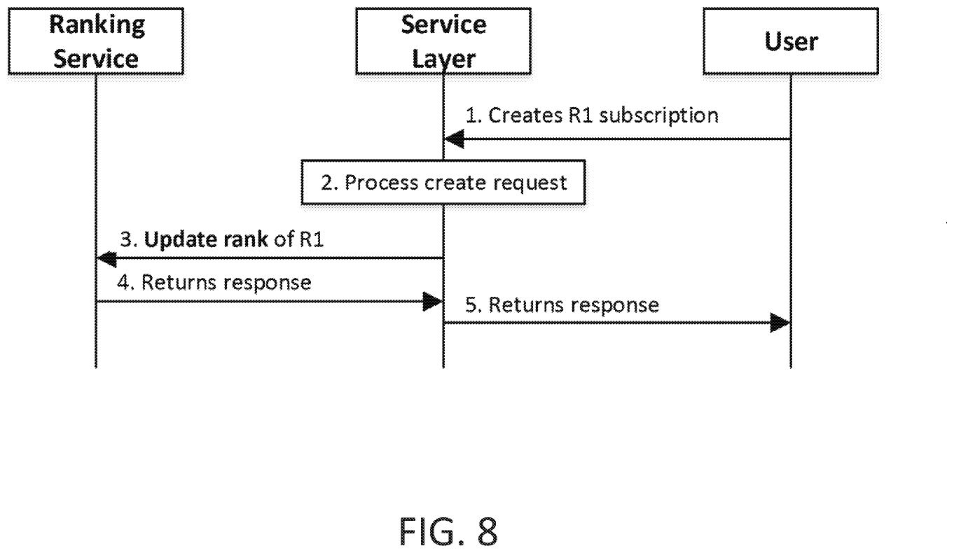

The rank value may have a base value when a subscription is created and, depending on the number of notification targets, the rank value may be updated accordingly. The more the notification targets, the more popular the resource may be and the higher the rank value may be. As a result, the rank value may be greater with more notification targets. Once again, the Service Layer may be able to rank the parent resource that this subscription applies to. An example procedure for resource ranking based on SL subscriptions and notification targets is shown in FIG. 8:

At step 1, a user is interested in receiving notifications on changes to resource R1 and creates a subscription request for R1.

At step 2, the Service Layer processes the create subscription request and makes a determination on how to update the rank for resource R1. The Service Layer may examine the number of notification targets specified in the subscription as well as the creation of the subscription resource to obtain an appropriate value to update the rank of R1. Certain notification event criteria may also warrant a higher rank value if they are important.

At step 3, the Service Layer makes a request to update the rank of R1 using the value obtained in step 2. Alternatively, the Ranking Service may reference the Ranking Profile to obtain the rank value.

At step 4, the Ranking Service returns a response and may include the new rank for R1 as well.

At step 5, the Service Layer returns an appropriate response to the user.

The procedure of FIG. 8 describes an example case where the rank of a resource is increased due to the creation of a subscription resource. Similarly, the rank of a resource may be decreased if a subscription resource is deleted or if one or more notification targets are removed. These instances signify a reduction in popularity of the resource and the rank may be adjusted accordingly. Conversely, if one or more notification targets are added, the rank of a resource may be increased.

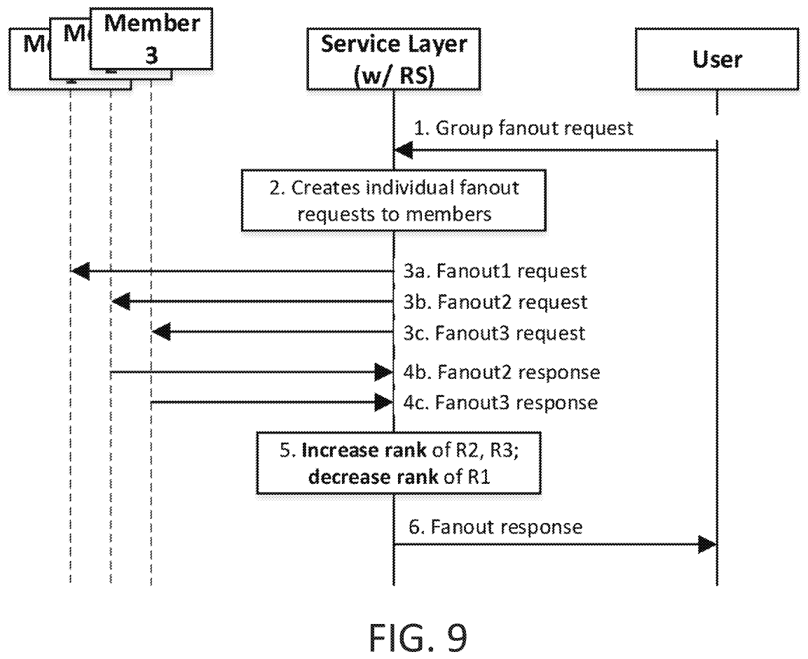

Resource ranking may be based on SL group fan-out responses. A SL fan-out operation occurs when a user targets a request towards a group resource. Usually, the group contains multiple members and the Service Layer may create individual requests targeting each member of the group, except for the cases where multicast or broadcast is used. The fan-out operation is an extension of a SL resource access but applied to the members of a group. Therefore, the event may trigger a ranking update to all resources that form the group. The rank value may be assigned the same value as the corresponding SL resource access rank value or it may be different to represent that these requests are a result of being members of a group. FIG. 9 shows an example SL fan-out operation targeting three members. The example shows how the rank of a resource may be updated based on whether a response is received from the member resource. This is important when group multicast or broadcast is used.

FIG. 9 shows an example flowchart for resource ranking based on SL group fan-out responses. The following describes in detail the steps of FIG. 9. Note that in this case, the Ranking Service is integrated as part of the Service Layer.

At step 1, a user makes a request targeting a group resource that contains three members.

At step 2, the SL processes the group request and creates individual fan-out requests to each member. In addition, the SL detects this is a ranking event and obtains the rank value associated with this event.

At step 3, the SL fans out the request to each of the members of the group.

At step 4, only two members of the group provides a response and the request times out for member 1.

At step 5, the SL increments the rank for resources R2 and R3 with the rank value obtained from Step 2 and decrements the rank of resource R1 with the associated rank value. Note that rank values may be different for successful and unsuccessful cases or they may be the same.

At step 6, the SL returns the appropriate response to the user.

Resource ranking may be based on SL announced resources. Announcing a resource to a remote Service Layer may expose the resource to more users. This event may increase the probability of the resource being found and accessed. This event does not necessarily indicate the resource is popular but with more exposure, the resource may eventually be popular. Therefore, this event may indicate the potential for the resource to be popular and may help with contributing to its rank. The rank value may be set appropriately to reflect the potential. In addition, the weight of this ranking event can be adjusted to reflect the importance of the potential of the resource to be popular.

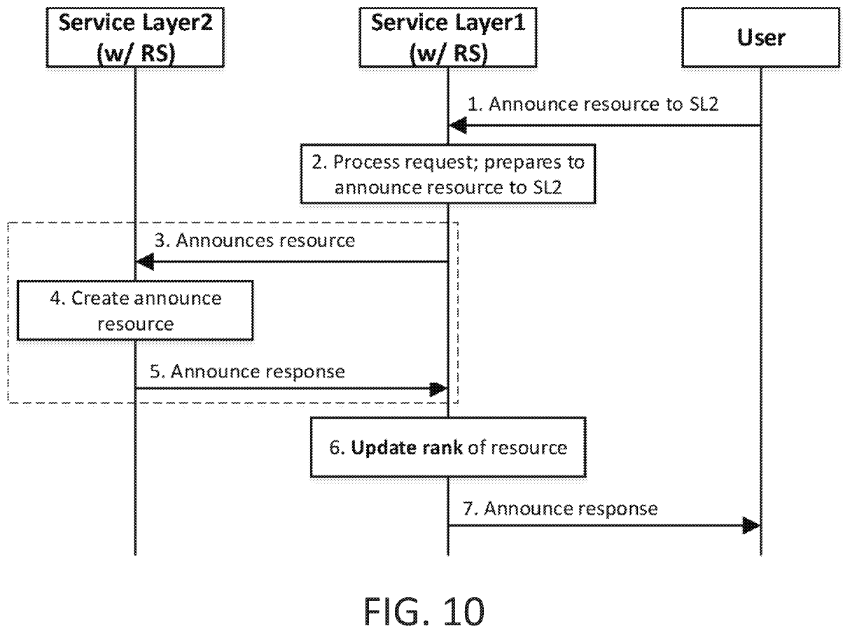

FIG. 10 shows an example flowchart of resource ranking based on a SL announced resource. The following describes in detail the steps of FIG. 10. Note that in this case, the Ranking Service (RS) is integrated as part of the Service Layer.

At step 1, a user makes a request to announce a resource to SL2.

At step 2, SL1 processes the request and detects that this is a ranking event. SL1 then retrieves the rank value associated with the ranking event of announcing resources from the Ranking Profile.

At step 3, SL1 announces the resource to SL2.

At step 4, SL2 creates the announced resource.

At step 5, SL2 returns an appropriate response to announced request.

At step 6, using the rank value obtained from step 2, SL1 updates the rank of the resource.

At step 7, SL1 returns an appropriate response to the user. If the user is the owner of the resource, the new rank for the resource may also be provided in the response.

The more a resource is announced to remote SLs, the higher the probability that resource eventually becomes popular. Conversely, the removal of an announced resource from a remote SL may reduce the rank of the corresponding resource on the local SL.

Resource ranking may be based on a most ranked list. The Ranking Service may have customized ranking lists it provides to rank resources based on weighting the individual ranking events differently for various purposes. For example, the Ranking Service may provide ranking lists for most recently updated, most recently created, most popular based on total rank, most accessed, most subscribed, etc. These ranking lists generate results that are herein referred to as “Most Ranked Lists.” The lists may be used in combination with search criteria to indicate the results presented by the list (e.g., most accessed for the past 30 days).

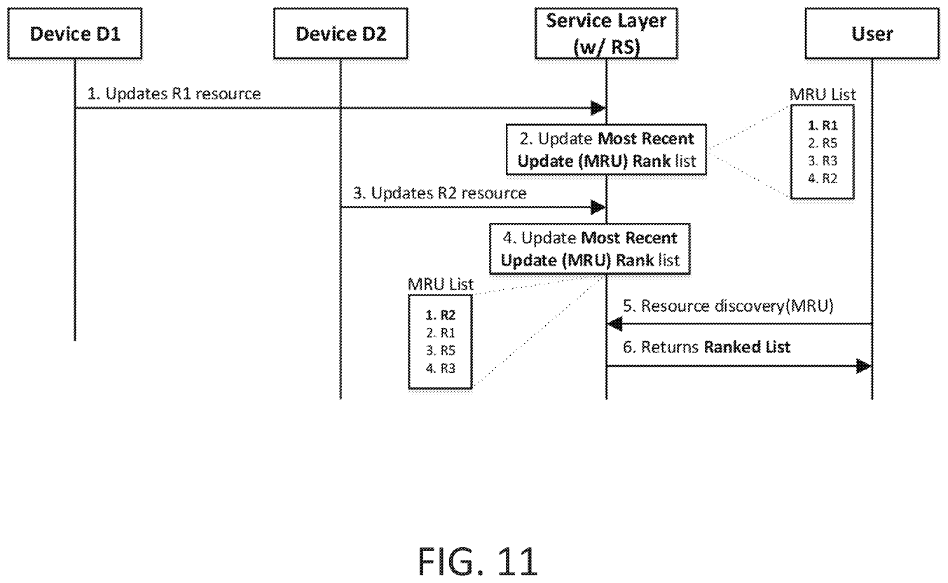

FIG. 11 shows an example flowchart of resource ranking based on a most ranked list. The following describes in detail the steps of FIG. 11. Note that in this case, the Ranking Service is integrated as part of the Service Layer and both devices D1 and D2 have already been ranked by the Ranking Service.

At step 1, device D1 makes an update request to resource R1. An appropriate response is returned, which is not shown.

At step 2, the SL/Ranking Service detects the request from Step 1 as a ranking event and updates the rank of resource R1. In addition, the SL updates the Most Recently Updated (MRU) list it maintains.

At step 3, some time later, device D2 updates resource R2. An appropriate response is returned, which is again not shown.

At step 4, the SL/Ranking Service detects the request from step 3 as a ranking event and updates the rank of resource R2. In addition, SL updates the MRU list to reflect that R2 was the most recently updated resource.

At step 5, a user makes a request to discover resources provided by the MRU list.

At step 6, the SL returns the list of resources it maintains in the MRU list to the user.

Note that the Most Ranked Lists are customized rankings provided by the SL/Ranking Service to offer users additional ranking capabilities. The list may be created based on certain ranking criteria that may be important to users and may use the underlying rankings the Ranking Service maintains for each resource.

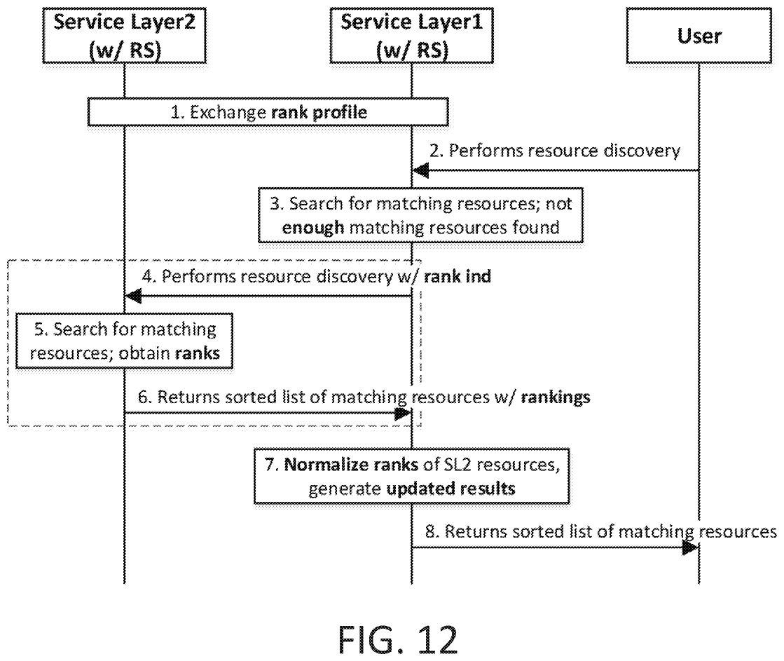

Disclosed herein are methods and systems that enable a service layer to augment resource rankings. A Service Layer may proactively augment its ranking by performing communications with remote SLs and to obtain rankings of resources on remote SLs. SLs may perform remote resource discovery on behalf of users when there are not enough ranked resources found in the local SL. The results from the remote resource discovery may be combined with the ranked results found locally. Additionally, a SL may augment the rankings of announced resources on remote SLs whenever there is a retargeting request to the original resource on the remote SL. Further, a SL may rank remote SLs based on interactions with the remote SL over a period of time. A higher rank for a remote SL may imply that the resources on that SL are more popular than resources from other remote SLs. This ranking can then be factored into ranking announced resources from remote SLs. Note that in FIGS. 12-14 discussed below, the Ranking Service may be integrated with the Service Layer.

Methods for remote service layer resource discovery are disclosed. For cases where a SL does not find enough ranked resources required for a resource discovery request, the SL may augment the resources found locally with results from performing resource discovery on remote SLs. The results from the remote SLs may then be combined with those resources found on the local SL. In order to ensure that rankings are normalized between the SLs, Ranking Profiles may be exchanged between SLs. The difference between the rank values of the Ranking Profiles may then be used to normalize the rank of the all the resources so that they can be compared against each other. The normalization may be realized through a ranking factor that is used to scale resource ranks from one SL for comparison to resource ranks from another SL. The ranking factor may be derived from comparing Ranking Profiles of the two SLs in question and the scaling may be performed by either SL as long as that SL has the appropriate Ranking Profiles.

FIG. 12 shows an example flow chart in which SL1 performs resource discovery on SL2 and augments the results found locally with the results returned from SL2 while normalizing the results received from SL2. The following describes in detail the steps of FIG. 12.

At step 1, SL1 and SL2 exchange the Ranking Profile each uses to generate ranks for the resources they host. The Ranking Profile may contain the rank values that were used to generate the rank of a resource. If the rank values are different, then SL1 may normalize the ranks of resources received from SL2 in order to compare the ranks properly.

At step 2, a user performs resource discovery for resources with a minimum rank specified by the user (e.g., a rank of at least 90 on a scale from 0 to 100). In addition, the user may specify that a minimum number of resources be returned in the discovery results (e.g. 10).

At step 3, SL1 processes the request and does not find enough resources that match the minimum rank. The resource may be of a type that may not be readily available in SL1.

At step 4, SL1 proactively performs resource discovery on SL2, which hosts more of the resource types that the user is looking for. For this request, SL1 includes a ranking indicator (e.g., “rank ind” in FIG. 10) which may help identify the appropriate ranking event and notify SL2 to include the ranks of the resources provided in the response. Note that SL1 may send resource discovery requests to multiple remote SLs it may know about.

At step 5, SL2 searches internally for matching resources to the discovery request and also obtains the ranks associated with the discovered resources.

At step 6, SL2 returns the resource discovery response with the list of resources and their rankings sorted to SL1.

At step 7, SL1 aggregates the results obtained from the remote SLs and may normalize the ranks of those resources if there are differences between the Ranking Profiles of the two SLs. SL1 updates the rankings of the remote resources and sorts them with those found previously in step 3. Since the resources from SL2 were normalized, their rankings can now be directly compared to the rankings of resources from SL1.

At step 8, SL1 returns a sorted list of the matching resources to the user.

Methods of updating rankings for announced resources are disclosed. Another proactive method SLs may perform to augment resource rankings occurs when requests are retargeted to resources hosted remotely. This may occur when a user makes a request targeting an announced resource and the SL needs to retarget the request to the original resource hosted on a remote SL. When retargeting the request, a SL may provide a rank indicator to obtain the latest rank associated with the resource. This rank can then be normalized and saved as the rank of the announced resource.

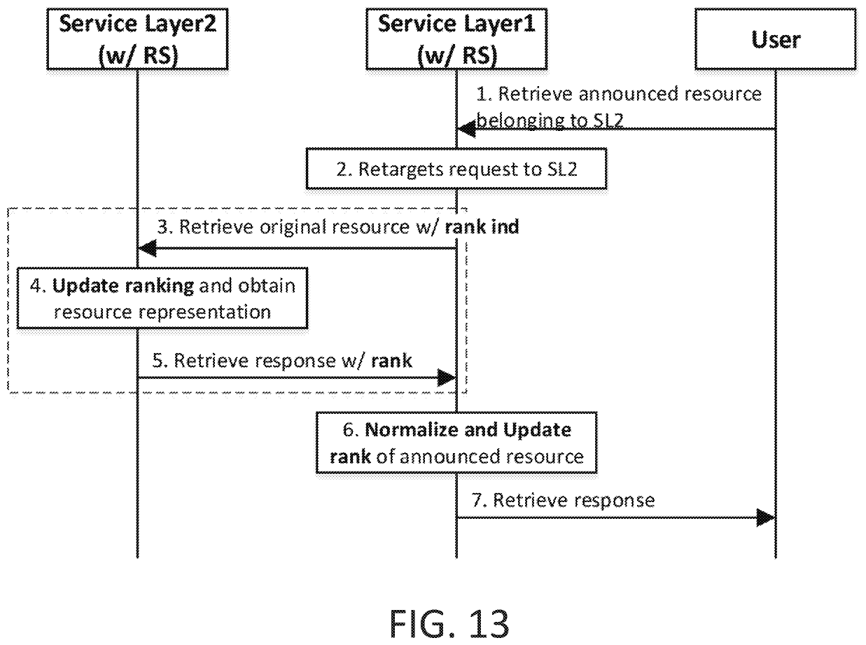

FIG. 13 shows an example procedure that a SL performs to obtain the rank of an announced resources from a remote SL. The following describes in detail the steps of FIG. 13. Note that, although not shown in the figure, SL1 and SL2 may have already exchanged each other's ranking profiles.

At step 1, a user retrieves an announced resource that belongs to a resource hosted on SL2.

At step 2, SL1 makes a determination that the request needs to be retargeted to SL2. At the same time, SL1 identifies this is an opportunity to update the ranking for this resource.

At step 3, SL1 retargets the request to SL2 and adds a rank indicator (“rank ind”) with the request. The rank indicator may be an identifier or URI of the announced resource on SL1. This indicator may help identify the appropriate ranking event and may cause a rank update to be performed and the rank of the resource be returned to SL1.

At step 4, SL2 updates the ranking for the resource and obtains the resource representation.

At step 5, SL2 returns a response with the resource representation and the rank of the resource.

At step 6, SL1 normalizes the ranking provided by SL2 based on the Ranking Profiles of each SL and updates the rank for the announced resource. The new rank for the announced resource can then be used in future resource discovery requests.

At step 7, SL1 forwards the resource representation obtained from SL2 to the user.

In another scenario, SL1 from FIG. 13 may provide the user with the URI of the resource hosted on SL2. The user may then access the resource directly from SL2 and provide a rank indication in the request. In response, SL2 may update the rank of the resource due to the occurrence of a resource discovery selection event and return the resource representation to the user. SL2 may proactively notify SL1 to update the rank of the announced resource.

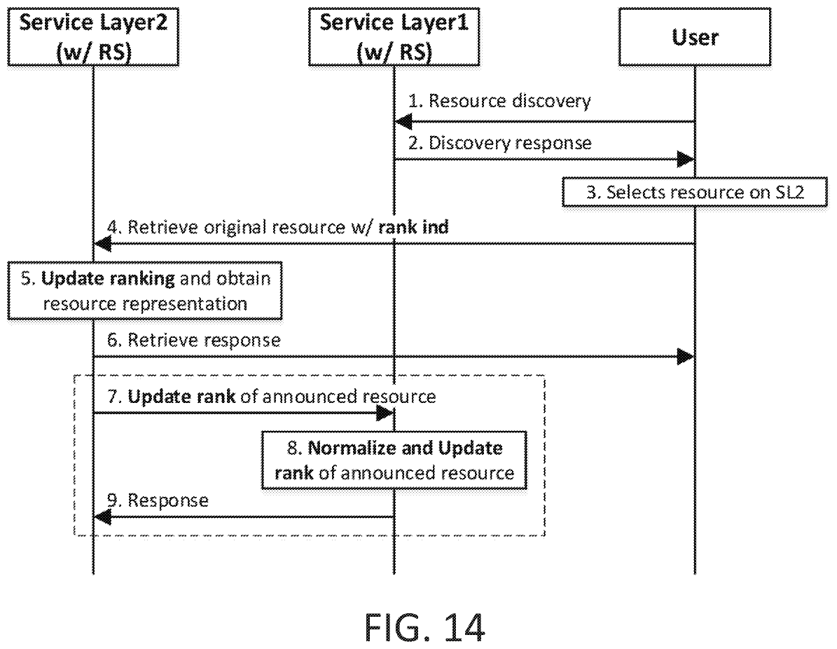

FIG. 14 shows an example flow chart of a SL proactively augmenting the rankings of announced resources. The following describes in detail the steps of FIG. 14. Note that, although not shown in the figure, SL1 and SL2 may have already exchanged each other's ranking profiles.

At step 1, a user performs resource discovery on SL1.

At step 2, SL1 returns a response with the list of URIs matching the search criteria. For announced resources, the response may include the URI of the original resource rather than the URI of the announced resource. This may occur if SL1 is either a Resource Directory or a standalone instance of the Ranking Service. In addition, the discovery request may have included an indication to return the original resource URI of announced resources.

At step 3, the user selects a resource that is hosted on SL2.

At step 4, the user then accesses the resource using the URI returned in step 2 by communicating directly to SL2. Included in the request is a rank indicator (rank ind) showing the URI or identifier of the announced resource. This indicator may help identify the appropriate ranking event and cause a rank update to be performed and the rank of the resource to be returned to SL1.

At step 5, SL2 updates the ranking for the resource and obtains the resource representation.

At step 6, SL2 returns a response with the resource representation and also the rank of the resource.

At step 7, SL2 proactively updates the rank of the announced resource on SL1 using the rank indication from step 4.

At step 8, SL1 normalizes the ranking provided by SL2 based on the Ranking Profiles of each SL and updates the rank for the announced resource. The new rank for the announced resource can then be used in future resource discovery requests.

At step 9, SL1 returns an appropriate response to SL2.

Methods for determining remote SL ranking weights and proactive weight adjustments are disclosed. In addition to resource rankings, SLs may also rank remote SLs. The rankings may be used for making decisions on which remote SLs to perform proactive resource discovery. Ranking remote SLs may be based on the number of announced resources from the remote SL, the number of retargeting requests to the remote SL, the types of resources hosted on the remote SLs, the total number of resources available in the remote SL, etc. The ranking of a remote SL may also be weighted against other remote SLs.

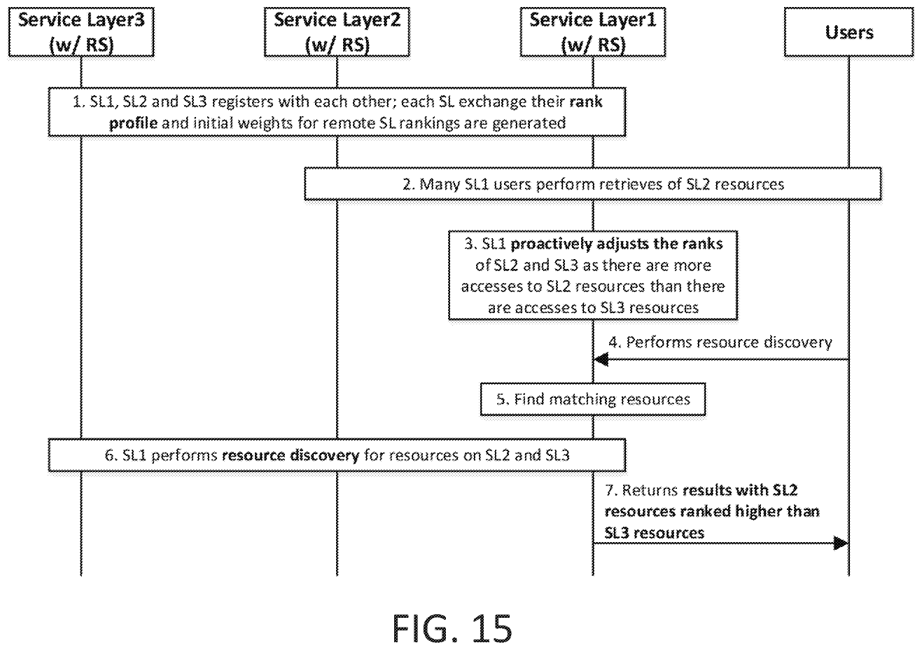

FIG. 15 shows a flow chart of example interactions between SLs for ranking remote SLs and how the remote SL ranking weight affects resource discovery results. The following describes in detail the steps of FIG. 15.

At step 1, SL1, SL2, and SL3 register to each other. During registration, each SL exchanges their ranking profile, which specifies the rank values each SL uses to rank the resources it hosts. SL1 uses the information in the ranking profile to compute normalized rankings SL1 uses for scaling resource rankings from SL2 or SL3. The normalized rankings may be necessary for SL1 to be able to compare its own resource rankings to those of remote SLs. Since the rank values may be different between SLs, the information in the ranking profile may allow each SL to scale the rankings to reflect the rank values it uses. For example, if SL1 has a rank value of 2 for SL resource discovery selection events and SL2 has a rank value of 3, SL1 will scale the ranks SL2 provides for resource discovery selection events by ⅔. In SL systems where all SLs use the same ranking profile, no normalization may be required.

At step 2, over a period of time, SL1 monitors and tracks the number of retargeting events made to each remote SL. In this case, SL1 finds that there are many requests that are retargeted to SL2 but not many requests that are retargeted to SL3.

At step 3, as a result of the monitoring performed in step 2, SL1 adjusts the SL ranks for SL2 and SL3. Unlike the ranking of resources, the rank of remote SLs may be set as a percentage. These rankings may be represented as weights a SL may use to scale the resource rankings obtained from remote SLs after accounting for the normalization performed as specified in step 1. Additionally or alternatively, the remote SL rank may be specified as numerical values from most preferred SL to least prefer SL in ascending or descending order and the prioritization of resources from those SLs made accordingly.

At step 4, a user performs resource discovery that includes resources from remote SLs.

At step 5, SL1 finds all matching resources locally for the discovery request from step 4.

At step 6, SL1 performs resource discovery on SL2 and SL3.

At step 7, SL1 normalizes and then scales the results obtained from SL2 and SL3 by the corresponding SL rank determined in step 3. Due to this step, resources from SL2 will typically appear before resources from SL3 for similar rank. However, a highly ranked SL3 resource may appear before a lower rank SL2 resource. The order of similarly ranked resources from SL1, SL2, and SL3 may depend on the ranking weights determined by step 3. The weights may be designed such that it is specified in relation to the host SL instead of remote SLs. For example, SL1 may have a ranking weight of 1, while SL2 may have a ranking weight of 1.02 and SL3 has a ranking weight of 0.97. In this instance, similarly ranked resources from SL2 will appear before resources from SL1 and lastly from SL3.

It is understood that the ranking weights described above are subject to change over time and may depend on the interactions between SLs. A host SL may monitor the retargeting requests to remote SLs and adjust the ranking weights based on the monitoring results. The frequency of adjustments to the weights may depend on the implementation of the SL or possibly based on configuration policies provided to the SL.

The ranking mechanisms discussed above focus on providing more customized discovery results to SL users. However, the SL Ranking Service may also offer mechanisms for resource owners to provide inputs on how to tailor the resources they own towards resource discovery results. These mechanisms may enable resource owners to target their resources toward the intended audience the resources were defined for.

A Resource Ranking Preference (RRP) profile may be defined by the SL to support such a feature. The RRP may be specified when a device is deployed as part of a service subscription, during SL registration, or created thereafter when the resource owner wants to target the resource for a particular audience. A RRP may contain the types of users or applications a resource is targeting, a timeframe when the resource may have elevated ranking potential (e.g., during work week, during weekends, etc.), the location where the discovery request was made, etc. The RRP may be specified on a resource basis or as an overall profile for all resources of the same owner. Table 1 shows an example of an RRP.

TABLE 1
Resource Ranking Preference Profile Example

| Ranking Preference | Short Name | Description |
|---|---|---|
| User Types | rput | The types of SL users or applications (i.e. requestors) that the |
| | | resource is targeting. When such a user or application is making a |
| | | discovery request, elevate the ranking of the indicated resource to |
| | | appear near the top of the discovery results. |
| Time Preference | rptp | A preferred time when the resource may appear near the top of the |
| | | discovery results if other preferences are matched. |
| Location Preference | rplp | A preferred location from which a resource discovery request is |
| | | made. When such a request is made, elevate the ranking of the |
| | | indicated resource to appear near the top of the discovery results. |
| Resource Tiers | rprt | A SL may be configured with different resource tiers in which a |
| | | resource belongs to. This information may be used to further sort |
| | | the resources in discovery results. The higher the tier, the higher in |
| | | the discovery result the resource may appear in. |
| Priority Order | rppo | Indicates the priority of the ranking preferences specified by the |
| | | RRP in which to elevate the ranking of a particular resource. |

The various ranking preferences listed in Table 1 may be prioritized by the resource owner in terms of importance using the Priority Order preference. This priority may help the Ranking Service select the best match of a resource to the intended resource audience (e.g., resource discovery requestor). The Priority Order (rppo) preference may be specified with the order the resource owner wants to emphasize when elevating the ranking of one of its resources. For example, a resource owner may specify the rppo as {rput, rppl, rppt, rprt} to indicate to the Ranking Service that the User Types preference is the most important criteria for matching the resource to. When a requestor is one of the indicated user types, the Ranking Service may list the associated resource near the top of the discovery results.

Once an RRP is configured and put in effect, the Ranking Service may use the preferences provided to better match the needs of requestors to resource owners. When performing customized ranked discovery, the Ranking Service may emphasize the ranking preferences found in the RRP over the rankings obtained from the individual ranking events. Thus, the resource discovery results may be able to provide the best match between requestors and resource owners.

To use the features provided by the Ranking Service, users may be able to specify the ranking criteria used for sorting the resource discovery results. The criteria may be specified in the resource discovery request or in a Customize Sorting Profile. The SL may use the criteria to sort the results according to the rank of the resources. The user may additionally or alternatively specify that the discovery result be customized for the user's needs based on configurations provided during registration and/or based on previous requests. The user may specify that only the best ranked resource be returned to a discovery request for cases in which the user does not want to parse through a list of ranked resources. This option is referred to as Best Ranked Resource Discovery and may be applicable when the requestor is a constrained device with limited resources and wants to simplify post processing of the discovery results. The Ranking Service may utilize information in RRP profiles to find the best match to the user's query.

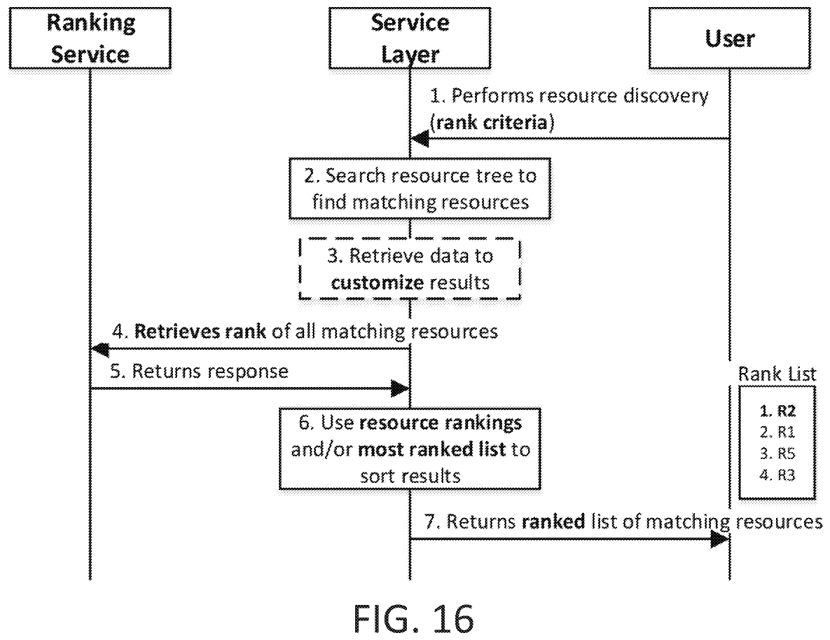

FIG. 16 shows an example of a user specifying the ranking criteria in a resource discovery request to indicate how the SL is to sort the discovery results. The ranking criteria is included along with the resource discovery query string, which specifies what the user is trying to discover. One or more ranking criteria may be specified to provide the sorting required by the user. Table 2 shows some example ranking criteria available to users.

TABLE 2
Examples of Resource Discovery Ranking Criteria

| Ranking Criteria | Short Name | Description |
|---|---|---|
| Best Ranked Resource Discovery | brrd | Request the SL only return the best ranked resource found; |
| | | may be used in combination with other sorting criteria |
| Customize Resource Discovery | crd | Use the Ranking Preference configured profile to customize |
| | | sorting resource discovery results |
| Include remote resource discovery | irrd | Requests that the SL also include resources from a remote SL |
| | | resource discovery procedure |
| Sort on Resource | srds | Sort resource discovery results based on resource discovery |
| Discovery Selection Rank | | selection rank |
| Sort on Resource Access Rank | srar | Sort resource discovery results based on resource access rank |
| Sort on Subscription- | ssnr | Sort resource discovery results based on the number of |
| Notification Rank | | subscriptions and notification targets rank |
| Sort on Total Rank | str | Sort resource discovery results based on total rank |
| Sort on Most Ranked List | smrl | Sort resource discovery results based on the specified Most |
| | | Ranked Lists; user may specify which most ranked list to use |

The following describes in detail the steps of FIG. 16.

At step 1, a user performs a resource discovery request and includes one or more ranking criteria. A Customize Sorting Profile may be provided at an earlier time in which rank criteria are included and associated with the user.

At step 2, the SL searches its resource tree and locates all resources matching the search criteria provided by the user.

At step 3, if the request from step 1 includes ranking criteria to perform customized ranked discovery, the SL may retrieve the Customize Sorting Profile for the user and also any available information from past searches.

At step 4, the SL retrieves the rank for all the resources found in step 2 from the Ranking Service.

At step 5, the Ranking Service returns the ranks for the requested resources.

At step 6, using the ranking criteria provided in step 1 and the data obtained from step 3 if a customized ranked discovery is requested, the SL sorts the resource discovery results according to sorting preference. The SL may need to update the appropriate most ranked list in the process.

At step 7, the SL returns the resource discovery results sorted according to the ranking criteria provided by the user.

The Ranking Service may be able to provide customized ranked discovery based on a user's preference and past search queries. A Customize Sorting Profile may be configured by the user during SL registration or some time thereafter to provide the user's preference that the Ranking Service may use to provide customized results. In addition, the Ranking Service may also gather information based on previous resource discovery searches and the resulting actions as well as resource discovery selection events of other SL users as shown in step 8 of FIG. 6. Table 3 shows some examples of the sorting preferences that may be found in a Customize Sorting Profile.

TABLE 3
Example of a Customize Sorting Profile

| Sorting Preference | Short Name | Description |
|---|---|---|
| Minimum Rank | cmr | The minimum rank the Ranking Service may include in resource |
| | | discovery results; any resource whose rank is below this value |
| | | should be omitted from appearing in the results |
| Sort Preference | csp | Specifies the sorting criteria to apply to resource discovery results |
| | | (see Table 2). |
| Types of resources | ctr | The types of resources that are of interest to the user and applied to |
| | | resource discovery queries; the Ranking Service may use this |
| | | information to cross reference saved resource discovery selection |
| | | events from other users with the same device type (refer to Step 8 of |
| | | FIG. 6) or to match with preferences provided in Resource Ranking |
| | | Preference profiles. |
| Include remote resources | cirr | Specifies that the SL should include resources found on remote SLs |
| | | in the resource discovery results; this may cause the SL to perform a |
| | | remote SL resource discovery procedure |
| Minimum # resources | cmnr | The minimum number of resources to include in resource discovery |
| | | results; this may cause the SL to perform a remote SL resource |
| | | discovery procedure |
| Default filter criteria | cdfc | A list of default filter criteria may be provided which will be used to |
| | | customize the resource discovery request |

To request customized ranked discovery, a user may specify the “crd” ranking criteria in a resource discovery request. The SL in conjunction with the Ranking Service may use the information in the Customize Sorting Profile to sort the resource discovery results. The process may involve, for example, performing remote SL resource discovery, retrieving previous resource discovery selection events saved, retrieving previous resource discovery queries, matching with preferences in Resource Ranking Preference profiles, and sorting all matching results according to the sorting preferences of the Customize Sorting Profile. For example, if a minimum rank is specified along with a sort preference for subscription-notification rank, the Ranking Service may only sort resources with a subscription-notification rank greater than the minimum rank specified.

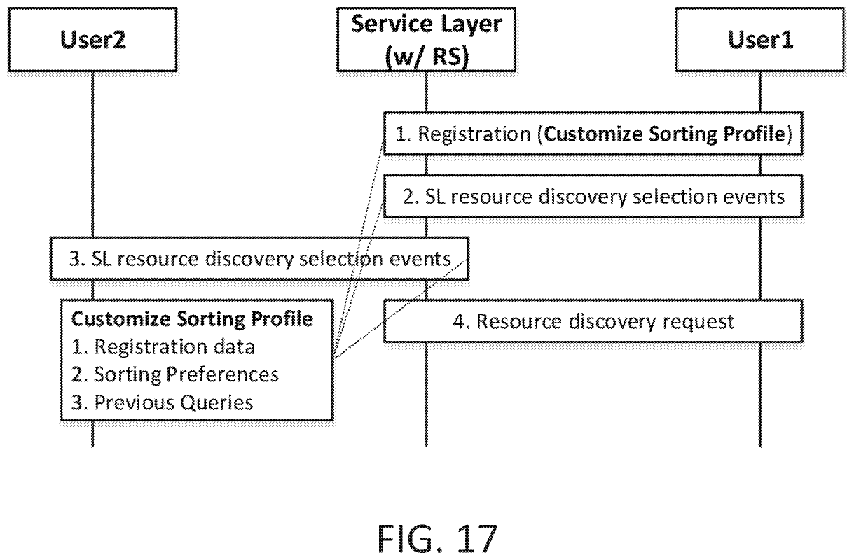

FIG. 17 shows an example flow chart of a SL customized ranked discovery procedure. The following describes in detail the steps of FIG. 17.

At step 1, User1 registers to the SL and specifies a Customize Sorting Profile. The SL creates a sorting profile for User1 and if “Types of Devices” are provided, the Ranking Service may save resource discovery selection events detected for the same types of devices specified. To minimize overhead, the Ranking Service may only save resource URIs that were selected in the resource discovery selection event. These resource URIs may be added to the sorting profile as resources selected in previous queries. These resources may then be added to future discovery results that are customized for a user.

At step 2, User1 performs resource discovery queries and the result of the resource discovery selection events are saved.

At step 3, User2 may trigger resource discovery selection events that are saved since User2's device type matches those specified in the Customize Sorting Profile.

At step 4, when User1 again performs resource discovery and a request for custom results, the SL and Ranking Service use the sorting preferences provided in the Customize Sorting Profile and also any saved resource URIs of previous resource discovery selection events to sort the results accordingly. In addition, if Resource Ranking Preference profiles are available, the Ranking Service may elevate the associated resources higher in the discovery result.

In some cases, IoT devices may not want to get a list of ranked results but just the best result so that the device does not need to parse a list of results. This is especially useful for constrained devices that may not have the capability to parse the list of resource URIs and make a determination of which resource to select. The Ranking Service can support these cases through the Best Ranked Resource Discovery procedure.

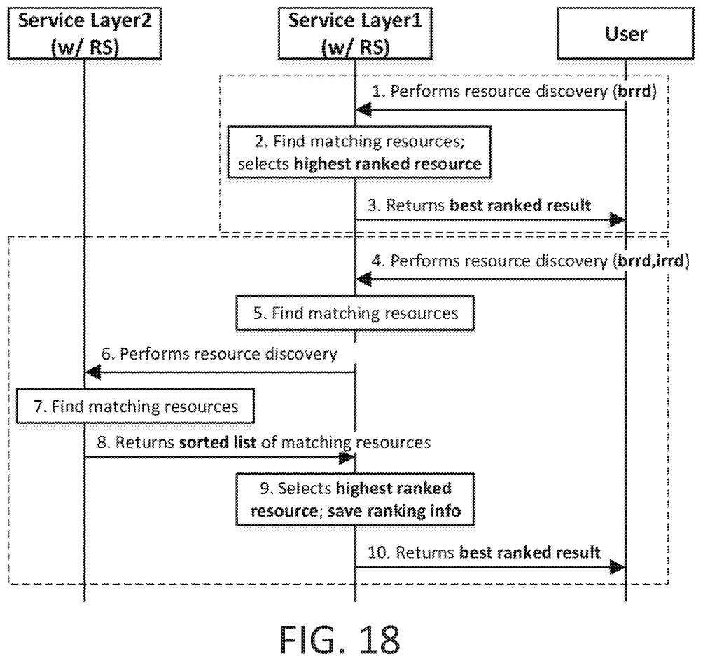

FIG. 18 shows two uses of the Best Ranked Resource Discovery procedure using the brrd ranking criteria—one to discover only local SL resources and another to discover both local and remote SL resources. In both cases, only the resource with the highest rank will be returned to the user. The following describes in detail the steps of FIG. 18.

At step 1, a user initiates the Best Ranked Resource Discovery procedure by include the brrd ranking criteria in the resource discovery request.

At step 2, SL1 searches its resource tree to find all matching resources and selects the highest ranked resource. When RRP profiles are available, the Ranking Service may elevate the associated resources to provide better matching of resources to their target audience.

At step 3, SL1 returns the highest ranked resource to the user, which the user can then access without needing to select one from a list.

At step 4, the user then initiates another Best Ranked Resource Discovery procedure by including the brrd ranking criteria in the resource discovery request. This time, the user wants to also discover remote resources in SL2 and includes the irrd ranking criteria.

At step 5, SL1 searches its resource tree to find all matching resources.

At step 6, due to the irrd ranking criteria, SL1 performs resource discovery on SL2 using the same search criteria provided by the user in step 4.

At step 7, SL2 searches its resource tree to find all matching resources.

At step 8, SL2 returns a sorted list of matching resources to SL1.

At step 9, SL1 may need to first normalize the results received from SL2 and aggregate all matching resources together. SL1 may then select the highest ranking resource. When RRP profiles are available, the Ranking Service may elevate the associate resources to provide better matching of resources to their target audience. SL1 may also save ranking information of SL2 announced resources that correspond to resources provided in step 8 after normalization.

At step 10, SL1 returns the highest ranked resource to the user.

Exemplary embodiments are provided below to demonstrate how the SL resource ranking can be applied to Service Layer technologies such as oneM2M (e.g., oneM2M TS-0001, Functional Architecture, V3.7.0 (hereinafter “oneM2M TS-0001”)) and OCF (e.g., OCF Core Specification, v1.3.0).

The Ranking Service may be realized as a Common Services Function (CSF) of a oneM2M Common Services Entity (CSE). The Ranking Service CSF may have the functionalities of ranking oneM2M resources and providing the normalization function between resource rankings of different CSEs. It may also initiate all the SL methods used to augment the resource rankings and process requests from AEs to provide ranking services such as the best ranked result or a customized ranked discovery.

In order for the Ranking Service CSF to perform the functionalities mentioned above, several oneM2M resources and/or attributes may be defined. The Ranking Profile may be a resource managed by CSE administrators that is located under the CSEBase resource and has the example resource specific attributes listed in Table 4. Each attribute contains rank value pairs for successful and unsuccessful cases to increment or decrement, respectively, the rank of a resource that is being managed by the Hosting CSE.

TABLE 4
Proposed oneM2M <rankingProfile> Resource Attributes

| Attributes of | | | | <rankingProfileAnnc> |
|---|---|---|---|---|
| <rankingProfile> | Multiplicity | RW/RO/WO | Description | Attributes |
| Universal and | * | * | See clause 9.6.1.3 of oneM2M TS-0001. | OA |
| common attributes | | | | |
| rankingProfileID | 1 | WO | An identifier that associates to this ranking | NA |
| | | | profile in which the ranking events and rank | |
| | | | values are obtained from. The rank of | |
| | | | resources is then computed from the rank | |
| | | | values present in this profile. | |
| rvResDiscSelection | 0 . . . 1 | RW | The rank values for resource discovery | NA |
| | | | selection events. | |
| rvSubscription | 0 . . . 1 | RW | The rank values for subscriptions and | NA |
| | | | notification target events. Note that this | |
| | | | attribute supersedes the resource dependent | |
| | | | attributes for CRUD listed below. | |
| rvFanoutResponse | 0 . . . 1 | RW | The rank values for group fanout response | NA |
| | | | events | |
| rvAnnouncement | 0 . . . 1 | RW | The rank values for announcement events | NA |
| rvResourceCreate | 0 . . . 1 | RW | The rank values for resource create events that | NA |
| | | | occurs for child resources of a ranked | |
| | | | resource. | |
| rvResourceRetrieve | 0 . . . 1 | RW | The rank values for resource retrieve events, | NA |
| | | | which includes retrieves of the ranked resource | |
| | | | and any child resources. | |
| rvResource Update | 0 . . . 1 | RW | The rank values for resource update events, | NA |
| | | | which includes updates of the attributes of | |
| | | | ranked resources and also attributes of any | |
| | | | child resources. | |
| rvResourceDelete | 0 . . . 1 | RW | The rank values for resource deletion events of | NA |
| | | | any child resources of the ranked resource. | |
| [rankingEventAttribute] | 0 . . . n | RW | A custom attribute for any other ranking | NA |
| | | | events that the Hosting CSE manages. The | |
| | | | attribute contains the rank values associated | |
| | | | with that ranking event. | |

Additionally or alternatively, the ranking profile may be realized as a document that the Hosting CSE retrieves to obtain the rank values for ranking the events that the Hosting CSE manages. Table 5 shows a new rankingProfileURI attribute for the CSEBase resource that specifies the location where the ranking profile document may be stored.

TABLE 5
Proposed oneM2M CSEBase Resource Attribute

| Attributes of | | | |
|---|---|---|---|
| <CSEBase> | Multiplicity | RW/RO/WO | Description |
| Universal and | * | * | See clause 9.6.1.3 of oneM2M TS-0001. |
| common attributes | | | |
| rankingProfileURI | 0 . . . 1 | WO | Contains the URI of a definition file or an |
| | | | identifier for the ranking profile that defines all |
| | | | the rank values associated with the |
| | | | corresponding ranking events the Hosting CSE |
| | | | manages. |

Each resource that is being ranked by the Hosting CSE may have a new common attribute to store its ranking. The new rank common attribute shown in Table 6 is present for all resources the Hosting CSE maintains a ranking for. The attribute may be of complex type to store the individual rankings based on the different ranking events as well as a total ranking that is a composite ranking computed by the Hosting CSE. A rankingProfileID attribute may be used to indicate the ranking profile that the rank of the resource was generated with.

TABLE 6
Proposed oneM2M Attributes for Ranking Resources

| Attribute Name | Description |
|---|---|
| rankingProfileID | An identifier that associates to a ranking profile used to compute the |
| | ranking of a resource. |
| rankingControlPolicyID | The identifier of a rankingControlPolicy that the resource owner may |
| | specify to assist the Ranking Service to match the resource with targeted |
| | requestors meeting certain criteria specified in the rankingControlPolicy. |
| rank | This is a common attribute that exists for resources that are ranked by the |
| | Hosting CSE. The attribute may be of complex type to provide individual |
| | ranks for the different events that trigger a ranking update as well as a |
| | composite rank computed by the CSE. |

A <rankingControlPolicy> resource may be created by resource owners to inform the Ranking Service of the intended audience for a resource. The Ranking Service may use the criteria presented in the policy to match the resource to discovery requests meeting those criteria. The resource owner may create an individual policy for each resource owned or may share the policy among multiple resources using the rankingControlPolicyID attribute shown in Table 6. The <rankingControlPolicy> resource may be a child resource of any of the following resources: <m2mServiceSubscriptionProfile>, <serviceSubscriberNode>, <serviceSubscribedAppRule>, <remoteCSE>, <AE>, or any other child resource under <remoteCSE> or <AE>. The rankingControlPolicyID may be a common or universal attribute. Table 7 shows some example resource attributes for the <rankingControlPolicy> resource.

TABLE 7
Proposed oneM2M <rankingControlPolicy> Resource Attributes

| Attributes of | | | | <rankingControlPolicy> |
|---|---|---|---|---|
| <rankingControlPolicy> | Multiplicity | RW/RO/WO | Description | Attributes |
| Universal and | * | * | See clause 9.6.1.3 of oneM2M TS- | OA |
| common attributes | | | 0001. | |
| requestorIDs | 0 . . . 1 (L) | RW | The intended audience of this | OA |
| | | | resource based on the type of | |
| | | | requestor IDs, e.g. based on | |
| | | | appName, App-ID, CSE-ID, M2M- | |
| | | | SP-ID, or any other type of | |
| | | | identifiers. When such a requestor is | |
| | | | making a discovery request, elevate | |
| | | | the ranking of the indicated resource | |
| | | | to appear near the top of the | |
| | | | discovery results. | |
| timePreference | 0 . . . 1 (L) | RW | A preferred time when the resource | OA |
| | | | may appear near the top of the | |
| | | | discovery results if other preferences | |
| | | | are matched. | |
| locationPreference | 0 . . . 1 (L) | RW | A preferred location from which a | OA |
| | | | resource discovery request is made. | |
| | | | When such a request is made, elevate | |
| | | | the ranking of the indicated resource | |
| | | | to appear near the top of the | |
| | | | discovery results. | |
| resourceTiers | 0 . . . 1 | RW | A SL may be configured with | OA |
| | | | different resource tiers in which a | |
| | | | resource belongs to and this | |
| | | | information may be used to further | |
| | | | sort the resources in discovery | |
| | | | results. The higher the tier, the higher | |
| | | | in the discovery result the resource | |
| | | | will appear in. | |
| priorityOrder | 0 . . . 1 (L) | RW | Indicates the priority of the ranking | OA |
| | | | preferences specified by the | |
| | | | <rankingControlPolicy> resource in | |
| | | | which to elevate the ranking of a | |
| | | | particular resource. | |

To support customized ranked discovery, a <sortingProfile> resource is disclosed which request originators may create within their AE resource. This resource may contain profile data that guides the Hosting CSE on what parameters to use when a customize resource discovery is requested by the originator. Table 8 shows a list of resource attributes for the <sortingProfile> resource. The <sortingProfile> resource may be replaced by a sortingProfileURI attribute in which the location of the sorting profile is found. This attribute may reside within the AE resource and the Hosting CSE may retrieve the sorting profile and use the data to perform customize resource discovery.

TABLE 8
Proposed oneM2M Customize <sortingProfile> Resource Attributes

| | | | | <sorting |
|---|---|---|---|---|
| Attributes of | | | | Profile> |
| <sortingProfile> | Multiplicity | RW/RO/WO | Description | Attributes |
| Universal and | * | * | See clause 9.6.1.3 of oneM2M TS-0001. | OA |
| common attributes | | | | |
| minimumRank | 0. . . 1 | RW | Specifies the minimum rank a discovered | OA |
| | | | resource must meet in order to be included in | |
| | | | the response to a customize resource discovery | |
| | | | request. | |
| sortPreference | 0. . . 1 | RW | The sorting preference to use when performing | OA |
| | | | a customize resource discovery. | |
| deviceTypes | 0. . . 1 (L) | RW | The types of devices the customize resource | OA |
| | | | discovery are interested in. | |
| Include remote resources | 0. . . 1 | RW | A flag to indicate whether remote SL resource | OA |
| | | | discovery should be performed. The discovery | |
| | | | results may be included with the resources | |
| | | | found in the Hosting CSE after accounting for | |
| | | | rank normalization. | |
| minimumNumberResources | 0. . . 1 | RW | The minimum number of resources to include | OA |
| | | | in a customize resource discovery response. | |
| defaultFilterCriteria | 0. . . 1 (L) | RW | Any default filter criteria to include in the | OA |
| | | | customize resource discovery request. | |

The user indication for requesting ranking results may be specified within a resource discovery request using the Ranking Criteria specified in Table 2. The Ranking Criteria can be used similar to how oneM2M's Filter Criteria are specified in a resource discovery request as shown in Table 9. The bold text shows the updates to the procedure for specifying the ranking criteria. Note that the rankingUsage parameter may be added to the Ranking Criteria listed in Table 2 similar to how the filterUsage parameter is part of the condition tag of the Filter Criteria conditions.

TABLE 9
oneM2M Discovery Procedure with Support for Resource Ranking
<resource> RETRIEVE

| | |
|---|---|
| Associated | Mca, Mcc, and Mcc′. |
| Reference Point | |
| Information in | All paramters defined in Table 8.1.2-3 of oneM2M TS-0001 apply |
| Request message | with the specific details for: |
| | For the allowed Result Content parameter options for Discovery |
| | related RETRIEVE, see clause 8.1.2 or oneM2M TS-0001. |
| | To: Address of the root of where the discovery begins. |
| | Filter Criteria: Filter criteria for searching and expected returned |
| | result. The filterUsage parameter shall be set in this case. |
| | Ranking Criteria: optional, the ranking criteria used to sort the |
| | returned result. The rankingUsage parameter shall be specified in |
| | this case with one or more Ranking Criteria. |
| | Discovery Result Type: optional, format of discovery results returned |
| | (see clause 8.1.2 of oneM2M TS-0001 for options applicable to |
| | Discovery, and how results shall be displayed). |
| Processing at | According to clause 10.1.3 of oneM2M TS-0001 with the following: |
| Originator before | Setup the RETRIEVE operation in the Request. |
| sending Request | Include the conditions in the filter criterion to limit the scope of |
| | the discovery results |
| | Specify the desired ranking criteria to use for sorting |
| | discovery results |
| | Specify the desired format of returned discovery results. |
| Processing at | According ti clause 10.1.3 of oneM2M TS-0001 with the following |
| Receiver | specific processing: |
| | Checks the validity of the Request (e.g. format of Filter Criteria |
| | and Rank Criteria). |
| | Checks if the request is in accordance with the M2M service |
| | subscription. |
| | May change the filter criteria according to local policies. |
| | Searches matched resources from the addressed resource |
| | hierarchy. Any resources whose status is marked as |
| | “INACTIVE” are not searched, as well as any child resources of |
| | these “INACTIVE” resources. |
| | Limits the discovery result according to DISCOVER privileges |
| | of the discovered resources. |
| | Limits the discovery result according to the upper limit on the |
| | size of the answer. |
| | If specified, sort the discovery results according to the Rank |
| | Criteria provided. |
| | The Hosting CSE shall read the values of all attributes belonging to |
| | the addressed resource structure and the references of all sub-resources |
| | and it shall build a representation of these. The Hosting CSE shall use |
| | the appropriate addressing (see clause 9.3.1 of oneM2M TS-0001) form |
| | for each element included in the list in accordance with the incoming |
| | request. If Filter Criteria is provided in the request, the Hosting CSE |
| | uses it identifying the resources whose attributes match the Filter |
| | Criteria. The Hosting CSE shall respond to the Originator with the |
| | appropriate list of discovered resources in the Hosting CSE. |
| | If the Filter Criteria includes filterUsage element set to |
| | “IPEOnDemandDiscovery”, the target is the <AE> resource and the |
| | Hosting CSE has no match from the discovery of existing resources, |
| | then the Hosting CSE shall send a NOTIFY request containing the |
| | Filter Criteria to the AE(i.e. pointOfAccess of the <AE> resource) and |
| | the Originator ID of this discovery request. When the CSE gets the |
| | successful NOTIFY response with the resource address(es) which are |
| | created under the <AE> resource, then the CSE shall check the |
| | DISCOVER privilege and return the address(es) to the Originator. |
| | When the CSE gets the unsuccessful NOTIFY response, then the CSE |
| | shall send the Response Status Code in the NOTIFY response to the |
| | Originator. |
| | The Hosting CSE may modify the Filter Criteria including upper limit |
| | provided by the Originator or the discovery results based on the local |
| | policies. |
| | If the size of the result list is bigger than the upper limit or the scope |
| | of discoverable resources, according to the Originator's access control |
| | policy or service subscription has been modified by the Hosting CSE, |
| | the full list is not returned. Instead, an incomplete list is returned and an |
| | indication is added in the response for warning the requestor. |
| | If Rank Criteria is provided in the request, the Hosting CSE uses |
| | the criteria to sort the results of all matching resources obtained |
| | from processing the Filter Criteria. If the Rank Criteria specified is |
| | for customized ranked discovery, the Hosting CSE will retrieve and |
| | evaluate both the <rankingControlPolicy> and the <sortingProfile> |
| | resources to determine the order of the discovery results to return |
| | to the originator. If the Rank Criteria specified is for Best Ranked |
| | Resource Discovery, only the best ranked resource is returned to |
| | the originator. For all other Rank Criteria, the resources returned |
| | to the originator are ranked according to the specified ranking |
| | type. |
| Information in | All parameters defined in table 8.1.3-1 of oneM2M TS-0001 apply |
| Response message | with the specific details for: |
| | Contains the address list of discovered resources expressed in |
| | any of the methods depicted in clause 9.3.1 of oneM2M TS- |
| | 0001. The address list may be empty if no result matching the |
| | filter criterion is discovered. |
| | Contains an incomplete list warning if the full list is not |
| | returned. |
| | If Rank Criteria was provided in the request, the response will be |
| | sorted accordingly |
| Processing at | According to clause 10.1.3 of oneM2M TS-0001. |
| Originator after | |
| receiving Response | |
| Exceptions | According to clause 10.1.3 of oneM2M TS-0001 with the following: |
| | The requesting M2M AE or CSE is not registered. |
| | The request contains invalid parameters. |
| | The on-demand discovery was rejected by the requested M2M |
| | Application. |

The Most Ranked List may be realized in oneM2M as a virtual, child resource of the CSEBase resource. This resource, when retrieved, may provide a list of “Most Ranked Lists” supported by the Hosting CSE. The Originator may then use the name of one of the Most Ranked Lists as a Ranking Criteria in resource discovery requests.

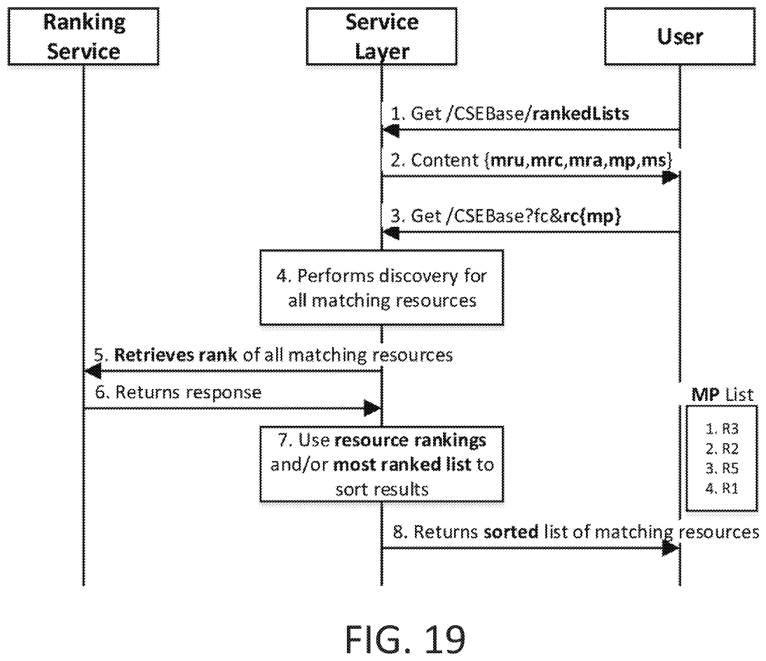

FIG. 19 shows a flow chart of an example procedure for retrieving one of the most ranked lists from the SL. The following describes in detail the steps of FIG. 19:

At step 1, a user targets the “rankedLists” virtual resource to retrieve a list of Most Ranked Lists supported by the Service Layer.

At step 2, the SL returns the Most Ranked Lists to the user. The contents may include mm (Most Recently Updated), mrc (Most Recently Created), mra (Most Recently Accessed), mp (Most Popular), and ms (Most Subscribed). Note that the Most Ranked Lists provided is SL dependent.

At step 3, the user selects one of the ranked lists provided by the SL in step 2 and includes it as a rank criteria (rc) in a resource discovery request along with the filter criteria (fc). In this case, the user selects the Most Popular (mp) list.

At step 4, the SL performs a discovery for all resources that matches the filter criteria.

At step 5, since the user specified a ranking criteria, the SL retrieves the rank of all matching resources.

At step 6, the Ranking Service returns the rankings of all matching resources to the SL.

At step 7, using the ranking criteria provided in step 1 and the resource rankings obtained from Step 6, the SL sorts the resource discovery results according to the rank of the resources based on the most popular criteria which the SL has implemented.

At step 8, the SL returns the resource discovery results sorted according to the Most Popular (MP) ranked list provided by the user in step 1.

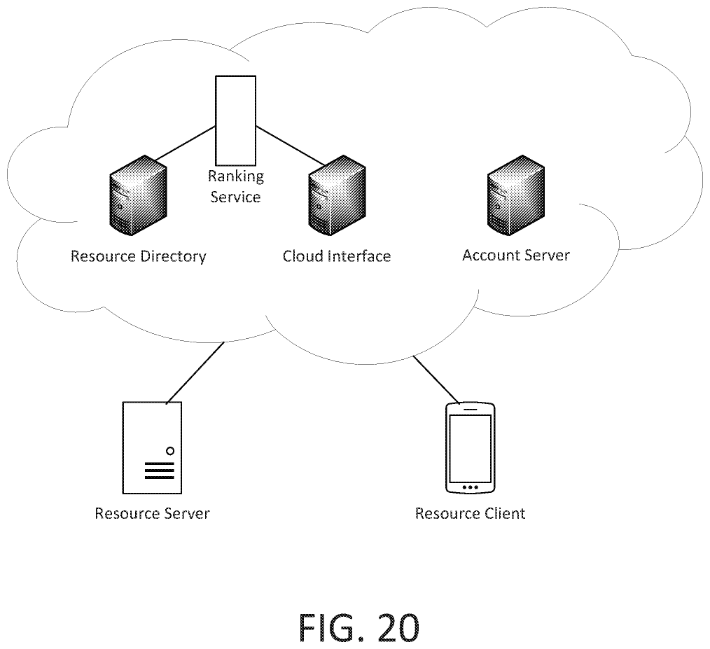

As shown in FIG. 20, the Ranking Service may be integrated into the OCF Cloud Native architecture. In OCF architecture, the Resource Directory (RD) provides search capabilities for resources in the system and the Cloud Interface provides the communications path between resource clients and resource servers. The Ranking Service may then connect to both the Resource Directory and the Cloud Interface to provide the same functionalities disclosed herein.

FIG. 20 shows the Resource Directory, the Ranking Service, and the Cloud Native Interface as separate, individual components of the OCF Cloud Native architecture for clarity. However, the components may all be integrated together or in combinations (e.g., Resource Directory and Ranking Service) to provide ranking services.

A Resource Directory may offer interfaces for endpoints to register resources that clients can discover and create groups from. Endpoints may register their resources using a CoRE Link Format, which may contain web links clients use to access the resources hosted on the endpoints. A resource ranking (rr) link attribute may be created upon an endpoint registration for each resource that the endpoint registers to the RD. This resource ranking may be managed by the Ranking Service based on the occurrence of the ranking events disclosed herein.

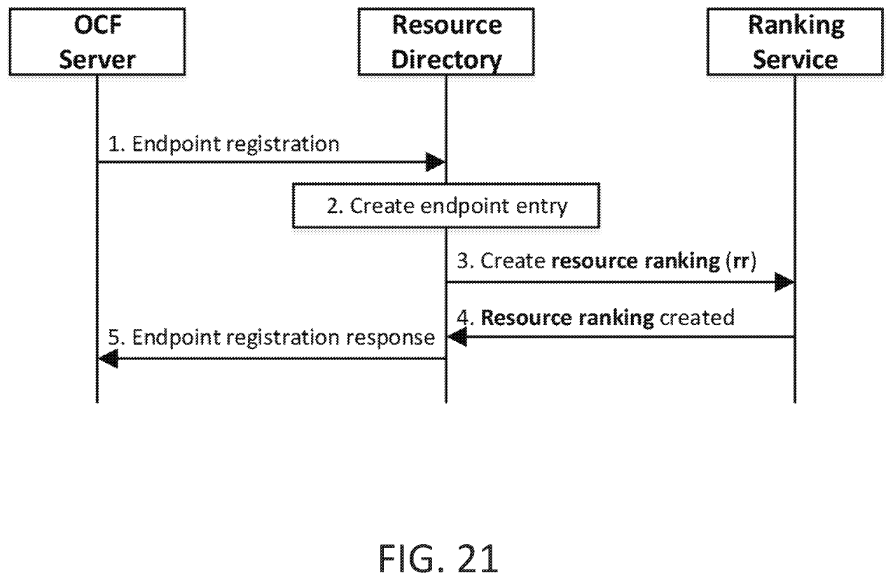

FIG. 21 shows an example flow chart for creating resource rankings for resources of an OCF server during endpoint registration to a Resource Directory. The following describes in detail the steps of FIG. 21.

At step 1, an OCF server performs endpoint registration to a Resource Directory. As part of this registration, one or more resources may be registered in a CoRE Link Format to the RD.

At step 2, the RD creates the endpoint registration entry along with the list of resources from the CoRE Link Format.

At step 3, the RD creates a resource ranking with the Ranking Service for each resource specified by the CoRE Link Format. The resource ranking may be realized as a link attribute “rr” attached to the corresponding CoRE Link Format for each resource.

At step 4, the Ranking Service returns an appropriate response to the RD.

At step 5, the RD returns an endpoint registration response to the OCF Server.

Once the resource rankings are created, the Resource Directory, the Ranking Service, and the OCF Cloud Native Interface may all communicate with one another to provide the ranking capabilities. The rank for each resource may be computed according to the ranking events that are detected.

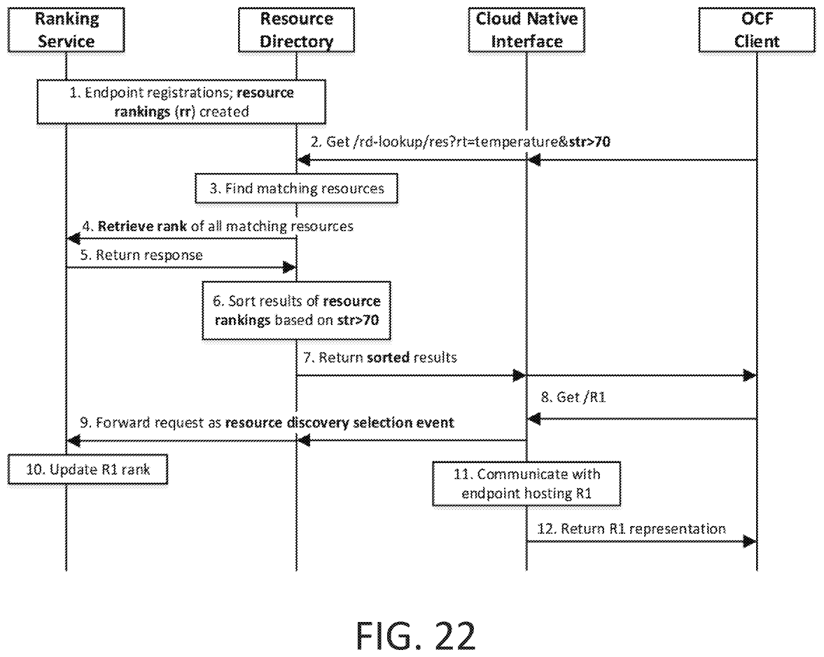

FIG. 22 shows a flow chart of an example procedure for ranking a resource based on a resource discovery selection event. The following describes in detail the steps of FIG. 22.

At step 1, OCF servers perform endpoint registrations to a Resource Directory. In this process, resource rankings may be created by the Ranking Service (as shown in FIG. 21) and may be represented as an “rr” link attribute in the Link Format associated with each resource that is registered by the OCF server.

At step 2, an OCF client performs resource discovery on the RD's Lookup interface for a resource type temperature and with a rank criteria of Sort on Total Rank (str).

At step 3, the Resource Directory searches for all matching resources with rt=temperature.

At step 4, the Resource Directory retrieves the rank associated with the discovered resources.

At step 5, the Ranking Service returns a response with all the ranking information.

At step 6, the Resource Directory sorts the list of all matched resources and their associated ranks, discarding any resources not matching the ranking criteria str>70.

At step 7, the Resource Directory returns the list of resources to the OCF client.

At step 8, the OCF client proceeds to retrieve resource R1 from the list provided by step 7.

At step 9, the OCF Cloud Native Interface forwards the request to the Resource Directory, which detects this is a resource discovery selection event and retrieves the rank value associated with such an event.

At step 10, the Ranking Service updates the rank associated with resource R1.

At step 11, the OCF Cloud Native Interface communicates with the endpoint hosting resource R1. Note that steps 9 and 11 may occur in parallel in response to the request from step 8. Alternatively, the request from step 11 may occur first and then follow by the request in step 9.

At step 12, the Cloud Native Interface returns the resource representation of R1 to the OCF client.

The Ranking Criteria listed in Table 2 may be specified as query string parameters in the RD Lookup request as shown in step 2 of FIG. 22. The specification of any of these ranking criteria may direct the Cloud Native Interface and/or the Resource Directory to provide ranking service in the response to the request.

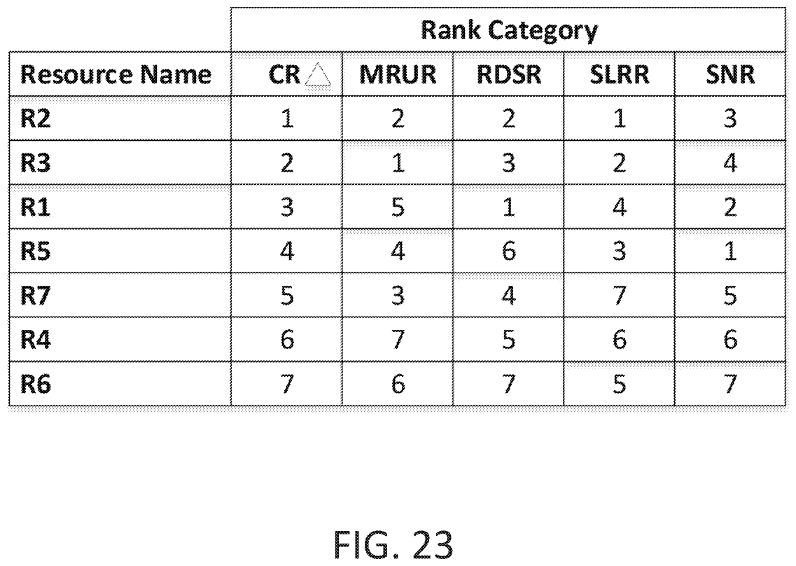

An example user interface provided by the Ranking Service is shown in FIG. 23. The user interface is shown as a table of the rankings for the different resources that can be sorted based on the ranking categories the RS provides. A user can select the ranking category to sort, as shown by the appearance of a triangle next to the ranking category name. In addition, the sorted column can be highlighted to provide another visual display of the ranked category for easier detection. The abbreviations shown in the table are: CR=Cumulative Rank, MRUR=Most Recently Updated Rank, RDSR=Resource Discovery Selection Rank, SLRR=Service Layer Retrieve Rank, and SNR=Subscription-Notification Rank.

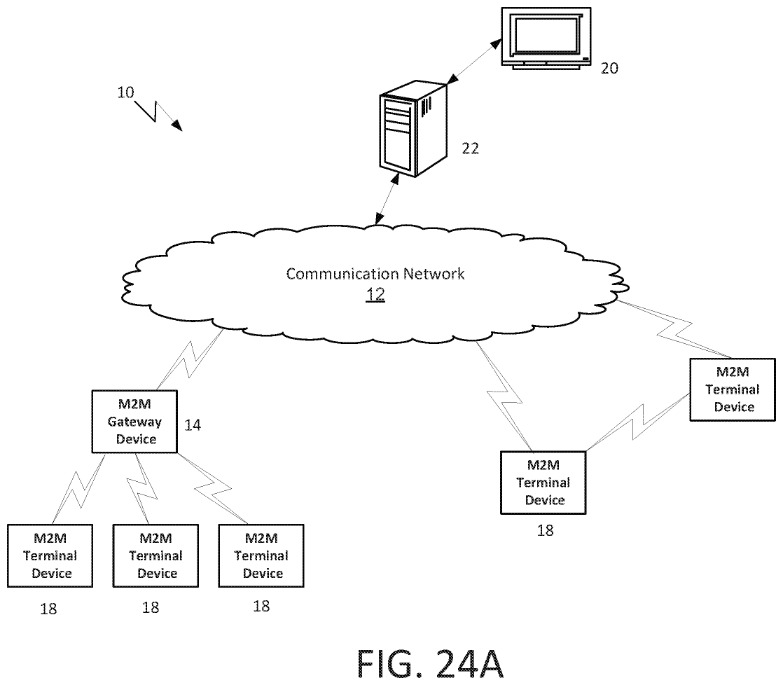

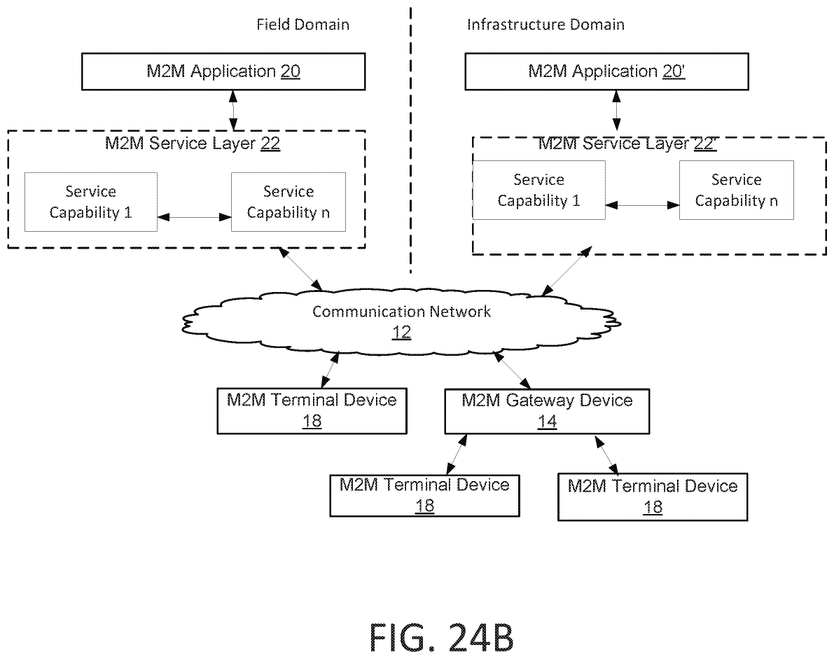

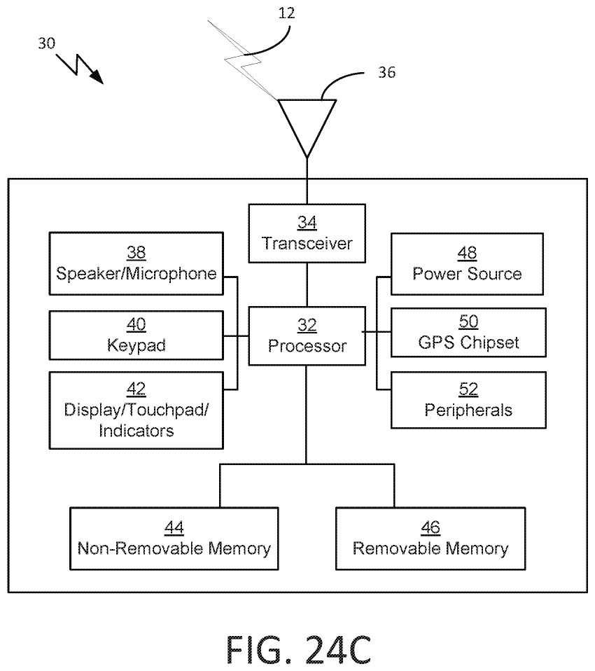

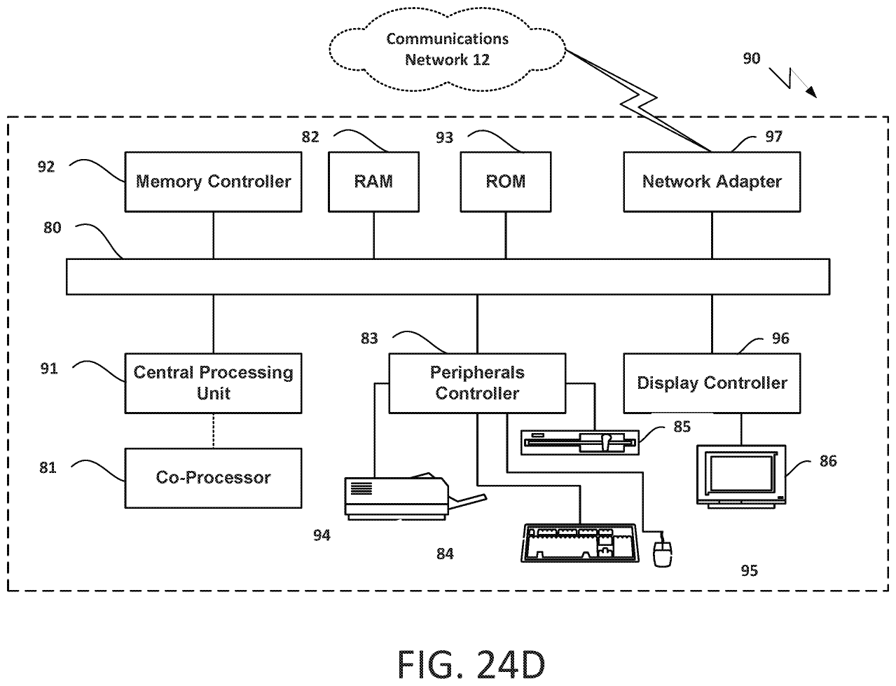

Any of the entities performing the steps illustrated in FIGS. 1, 3, 6-18, 20 and 21, such as the service layer, service layer device, service layer application, application entity, and the like, may be logical entities that may be implemented in the form of software (i.e., computer-executable instructions) stored in a memory of, and executing on a processor of, an apparatus configured for wireless and/or network communications or a computer system such as those illustrated in FIG. 24C or FIG. 24D. That is, the method(s) illustrated in FIGS. 1, 3, 6-18, 20 and 21 may be implemented in the form of software (i.e., computer-executable instructions) stored in a memory of an apparatus, such as the apparatus or computer system illustrated in FIG. 24C or FIG. 24D, which computer executable instructions, when executed by a processor of the apparatus, perform the steps illustrated in FIGS. 1, 3, 6-18, 20 and 21. It is also understood that any transmitting and receiving steps illustrated in FIGS. 1, 3, 6-18, 20 and 21 may be performed by communication circuitry of the apparatus/entity under control of the processor of the apparatus and the computer-executable instructions (e.g., software) that it executes.

FIG. 24A is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, M2M gateway, M2M server, or M2M service platform may be a component or apparatus of the IoT/WoT as well as an IoT/WoT Service Layer, etc. Any of the entities illustrated in any of FIGS. 1-3 and 5-21 may comprise a network apparatus of a communication system, such as the ones illustrated in FIGS. 24A-24D.

The service layer may be a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer may provide applications and/or various devices with access to a collection of or a set of the above-mentioned capabilities or functionalities, supported by the service layer, which may be referred to as a CSE or SCL. A few examples include but are not limited to security, charging, data management, device management, discovery, provisioning, and connectivity management which may be commonly used by various applications. These capabilities or functionalities are made available to such various applications via APIs which make use of message formats, resource structures and resource representations defined by the M2M service layer. The CSE or SCL is a functional entity that may be implemented by hardware and/or software and that provides (service) capabilities or functionalities exposed to various applications and/or devices (i.e., functional interfaces between such functional entities) in order for them to use such capabilities or functionalities.

As shown in FIG. 24A, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may be comprised of multiple access networks that provide content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 24A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain and Infrastructure Domain may both comprise a variety of different network apparatuses (e.g., servers, gateways, device, and the like) of the network. For example, the Field Domain may include M2M gateways 14 and devices 18. It will be appreciated that any number of M2M gateway devices 14 and M2M devices 18 may be included in the M2M/IoT/WoT communication system 10 as desired. Each of the M2M gateway devices 14 and M2M devices 18 are configured to transmit and receive signals, using communications circuitry, via the communication network 12 or direct radio link.

A M2M gateway 14 allows wireless M2M devices (e.g., cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or other M2M devices 18. The M2M devices 18 may also receive data from the M2M application 20 or an M2M device 18. Further, data and signals may be sent to and received from the M2M application 20 via an M2M Service Layer 22, as described below. M2M devices 18 and gateways 14 may communicate via various networks including, cellular, WLAN, WPAN (e.g., Zigbee, 6LoWPAN, Bluetooth), direct radio link, and wireline for example. Example M2M devices include, but are not limited to, tablets, smart phones, medical devices, temperature and weather monitors, connected cars, smart meters, game consoles, personal digital assistants, health and fitness monitors, lights, thermostats, appliances, garage doors and other actuator-based devices, security devices, and smart outlets.

Referring to FIG. 24B, the illustrated M2M Service Layer 22 in the field domain provides services for the M2M application 20, M2M gateways 14, and M2M devices 18 and the communication network 12. It will be understood that the M2M Service Layer 22 may communicate with any number of M2M applications, M2M gateways 14, M2M devices 18, and communication networks 12 as desired. The M2M Service Layer 22 may be implemented by one or more network apparatuses of the network, which may comprise servers, computers, devices, or the like. The M2M Service Layer 22 provides service capabilities that apply to M2M devices 18, M2M gateways 14, and M2M applications 20. The functions of the M2M Service Layer 22 may be implemented in a variety of ways, for example as a web server, in the cellular core network, in the cloud, etc.

Similar to the illustrated M2M Service Layer 22, there is the M2M Service Layer 22′ in the Infrastructure Domain. M2M Service Layer 22′ provides services for the M2M application 20′ and the underlying communication network 12 in the infrastructure domain. M2M Service Layer 22′ also provides services for the M2M gateways 14 and M2M devices 18 in the field domain. It will be understood that the M2M Service Layer 22′ may communicate with any number of M2M applications, M2M gateways and M2M devices. The M2M Service Layer 22′ may interact with a Service Layer by a different service provider. The M2M Service Layer 22′ may be implemented by one or more network apparatuses of the network, which may comprise servers, computers, devices, virtual machines (e.g., cloud computing/storage farms, etc.) or the like.

Referring also to FIG. 24B, the M2M Service Layers 22 and 22′ provide a core set of service delivery capabilities that diverse applications and verticals may leverage. These service capabilities enable M2M applications 20 and 20′ to interact with devices and perform functions such as data collection, data analysis, device management, security, billing, service/device discovery, etc. Essentially, these service capabilities free the applications of the burden of implementing these functionalities, thus simplifying application development and reducing cost and time to market. The Service Layers 22 and 22′ also enable M2M applications 20 and 20′ to communicate through various networks such as network 12 in connection with the services that the Service Layers 22 and 22′ provide.

The M2M applications 20 and 20′ may include applications in various industries such as, without limitation, transportation, health and wellness, connected home, energy management, asset tracking, and security and surveillance. As mentioned above, the M2M Service Layer, running across the devices, gateways, servers and other network apparatuses of the system, supports functions such as, for example, data collection, device management, security, billing, location tracking/geofencing, device/service discovery, and legacy systems integration, and provides these functions as services to the M2M applications 20 and 20′.

Generally, a Service Layer, such as the Service Layers 22 and 22′ illustrated in FIG. 24B, defines a software middleware layer that supports value-added service capabilities through a set of Application Programming Interfaces (APIs) and underlying networking interfaces. Both the ETSI M2M and oneM2M architectures define a Service Layer. ETSI M2M's Service Layer is referred to as the Service Capability Layer (SCL). The SCL may be implemented in a variety of different nodes of the ETSI M2M architecture. For example, an instance of the Service Layer may be implemented within an M2M device (where it is referred to as a device SCL (DSCL)), a gateway (where it is referred to as a gateway SCL (GSCL)) and/or a network node (where it is referred to as a network SCL (NSCL)). The oneM2M Service Layer supports a set of Common Service Functions (CSFs) (i.e., service capabilities). An instantiation of a set of one or more particular types of CSFs is referred to as a Common Services Entity (CSE) which may be hosted on different types of network nodes (e.g., infrastructure node, middle node, application-specific node). The Third Generation Partnership Project (3GPP) has also defined an architecture for machine-type communications (MTC). In that architecture, the Service Layer, and the service capabilities it provides, are implemented as part of a Service Capability Server (SCS). Whether embodied in a DSCL, GSCL, or NSCL of the ETSI M2M architecture, in a Service Capability Server (SCS) of the 3GPP MTC architecture, in a CSF or CSE of the oneM2M architecture, or in some other node of a network, an instance of the Service Layer may be implemented as a logical entity (e.g., software, computer-executable instructions, and the like) executing either on one or more standalone nodes in the network, including servers, computers, and other computing devices or nodes, or as part of one or more existing nodes. As an example, an instance of a Service Layer or component thereof may be implemented in the form of software running on a network apparatus (e.g., server, computer, gateway, device or the like) having the general architecture illustrated in FIG. 24C or FIG. 24D described below.

Further, the methods and functionalities described herein may be implemented as part of an M2M network that uses a Service Oriented Architecture (SOA) and/or a Resource-Oriented Architecture (ROA) to access services.

From a deployment perspective, a service layer can be deployed on various types of network nodes including servers, gateways and devices as shown in the various figures herein. Any such node, server, gateway, device, apparatus, or other logical entity of a communications network that implements service layer functionality or otherwise incorporates an instance of a service layer may be referred to herein as a service layer entity.

FIG. 24C is a block diagram of an example hardware/software architecture of an apparatus of a network, such as one of the entities illustrated in FIGS. 1-3 and 5-21, which may operate as an M2M server, gateway, device, or other network apparatus in an M2M network such as that illustrated in FIGS. 24A and 24B. As shown in FIG. 24D, the network apparatus 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The network apparatus 30 may also include communication circuitry, such as a transceiver 34 and a transmit/receive element 36. It will be appreciated that the network apparatus 30 may include any sub-combination of the foregoing elements while remaining consistent with an embodiment. This network apparatus may be an apparatus that implements the methods for service layer resource ranking and enhanced resource discovery, such as the methods operations illustrated and described in relation to FIGS. 1, 3, 6-18, 20 and 21.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the network apparatus in order to perform the various required functions of the network apparatus. For example, the processor 32 may perform signal coding, data processing, power control, input/output processing, and/or any other functionality that enables the network apparatus 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

As shown in FIG. 24C, the processor 32 is coupled to its communication circuitry (e.g., transceiver 34 and transmit/receive element 36). The processor 32, through the execution of computer executable instructions, may control the communication circuitry in order to cause the network apparatus 30 to communicate with other network apparatuses via the network to which it is connected. In particular, the processor 32 may control the communication circuitry in order to perform the transmitting and receiving steps described herein (e.g., in FIGS. 1, 3, 6-18, 20 and 21) and in the claims. While FIG. 24C depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other network apparatuses, including M2M servers, gateways, device, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 24C as a single element, the network apparatus 30 may include any number of transmit/receive elements 36. More specifically, the network apparatus 30 may employ MIMO technology. Thus, in an embodiment, the network apparatus 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the network apparatus 30 may have multi-mode capabilities. Thus, the transceiver 34 may include multiple transceivers for enabling the network apparatus 30 to communicate via multiple RATs, such as UTRA and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the network apparatus 30, such as on a server or a home computer. The processor 32 may be configured to control lighting patterns, images, or colors on the display or indicators 42 to reflect the status of an apparatus or configure an apparatus, and in particular underlying networks, applications, or other services in communication with the network apparatus. In one embodiment, the display/indicators 42 may present the graphical user interface illustrated in FIG. 24D and described herein.

The processor 32 may receive power from the power source 48, and may be configured to distribute and/or control the power to the other components in the network apparatus 30. The power source 48 may be any suitable device for powering the network apparatus 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the network apparatus 30. It will be appreciated that the network apparatus 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include various sensors such as an accelerometer, biometrics (e.g., fingerprint) sensors, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The network apparatus 30 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The network apparatus 30 may connect to other components, modules, or systems of such apparatuses or devices via one or more interconnect interfaces, such as an interconnect interface that may comprise one of the peripherals 52.

FIG. 24C is a block diagram of an example computing system 90 which may also be used to implement one or more network apparatuses of a network, such as the entities illustrated in FIGS. 1-3 and 5-21 and described herein, which may operate as an M2M server, gateway, device, or other network apparatus in an M2M network such as that illustrated in FIGS. 24A and 24B.

Computing system 90 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91. CPU 91 and/or coprocessor 81 may receive, generate, and process data related to the disclosed systems and methods for E2E M2M Service Layer sessions, such as receiving session credentials or authenticating based on session credentials.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86. Display 86, in combination with the computer-executable instructions executed by CPU 91, may generate and operate the graphical user interface illustrated and described in FIG. 24D and its accompanying description.

Further, computing system 90 may contain communication circuitry, such as for example a network adaptor 97, that may be used to connect computing system 90 to an external communications network, such as network 12 of FIG. 24A-24D, to enable the computing system 90 to communicate with other apparatuses of the network. The communication circuitry, alone or in combination with the CPU 91, may be used to perform the transmitting and receiving steps described herein (e.g., in FIGS. 1, 3, 6-18, 20 and 21) and in the claims.

It is understood that any or all of the systems, methods and processes described herein may be embodied in the form of computer executable instructions (i.e., program code) stored on a computer-readable storage medium which instructions, when executed by a machine, such as an apparatus of an M2M network, including for example an M2M server, gateway, device or the like, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any non-transitory (i.e., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computer.

The following is a list of acronyms relating to service layer technologies that may appear in the above description. Unless otherwise specified, the acronyms used herein refer to the corresponding term listed below:

AE Application Entity

CoRE Constrained RESTful Environments

CRUD Create, Retrieve, Update, Delete

CSE Common Services Entity

CSF Common Services Function

GUI Graphical User Interface

IETF Internet Engineering Task Force

IoT Internet of Things

M2M Machine-to-Machine

OCF Open Connectivity Foundation

RD Resource Directory

SEO Search Engine Optimization

SL Service Layer

URI Uniform Resource Identifier

URL Uniform Resource Locator

The following is a list of terms and definitions relating to service layer technologies that may appear in the above description. Unless otherwise specified, the terms and definitions used herein refer to the corresponding term listed below:

| Term | Definition |
|---|---|
| Resource Discovery | A ranking event in which a SL user performs resource discovery and |
| Selection event | then accesses one of the resources returned in the discovery result. |
| Most Ranked Lists | These lists are specialized ranking lists defined and provided by the |
| | Ranking Service/Service Layer to offer customized rankings beyond the |
| | basic ranking mechanisms for the different ranking events. Examples are |
| | Most Recently Updated, Most Popular, Most Subscribed, etc. |
| Rank criteria | A user specified criteria in a resource discovery request that indicates |
| | how the user wants the SL to rank and sort the search results. |
| Ranking event | A SL event that triggers the update of the rank of the targeted resource. |
| Ranking profile | Configuration information on how a SL/Ranking Service manages the |
| | resource rankings it provides. This profile is exchanged between SLs |
| | typically during registration to allow a SL to scale the ranking data |
| | provided by remote SLs for use in comparing with rankings it generates |
| | locally. |
| Ranking Service | An entity that provides and maintains ranking of SL resources. |
| Ranking update | The process undertaken by the Ranking Service to update the rank of a |
| | resource upon the occurrence of a ranking event. |
| Rank value | A value assigned to a ranking event in which the Ranking Service |
| | updates the rank of the targeted resource based on certain SL events. |

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

What is claimed:

1. A method performed at a service layer entity of a communications network, the method comprising:
determining a ranking profile that indicates, for one or more resources, one or more ranking events and one or more rank values associated with the one or more ranking events;
receiving an indication of the occurrence of one or more of the ranking events; and
updating, based on the occurrence of the one or more of the ranking events, and based on one or more of the rank values associated with the one or more ranking events, a resource rank of a resource hosted at the service layer entity.

2. The method of claim 1, wherein updating the resource rank of the resource hosted at the service layer entity comprises at least one of:
determining, based on the occurrence of the one or more of the ranking events and the one or more rank values associated with the one or more of the ranking events, to increase the resource rank of the resource; and
determining, based on the occurrence of the one or more of the ranking events and the one or more rank values associated with the one or more of the ranking events, to decrease the resource rank of the resource.

3. The method of claim 1, wherein the one or more ranking events comprise:
a resource discovery selection event;
a create, retrieve, update, or delete (CRUD) operation associated with the resource;
an update to a number of subscriptions and notification targets for the resource;
a determination that the resource has been announced; and
a response to a group fan-out operation of the resource.

4. The method of claim 1, further comprising generating a list of a plurality of resources hosted at the service layer entity based on a determined resource rank associated with each of the plurality of resources.

5. The method of claim 4, wherein generating the list of the plurality of resources comprises weighting a first one of the ranking events different than a second one of the ranking events.

6. The method of claim 1, further comprising creating a resource ranking preference profile that indicates one or more preferences for ranking a resource hosted at the service layer entity.

7. The method of claim 1, further comprising sending, to an other service layer entity, an indication that the resource rank of the resource has been updated at the service layer entity, wherein the other service layer entity is configured to update a ranking profile stored at the other service layer entity based on the received indication.

8. An apparatus comprising a processor and a memory, the memory storing computer-executable instructions which, when executed by the processor, implement a service layer entity of a communications network and cause the service layer entity to perform operations comprising:
determining a ranking profile that indicates, for one or more resources, one or more ranking events and one or more rank values associated with the one or more ranking events;
receiving an indication of the occurrence of one or more of the ranking events; and
updating, based on the occurrence of the one or more of the ranking events, and based on one or more of the rank values associated with the one or more ranking events, a resource rank of a resource hosted at the service layer entity.

9. The apparatus of claim 8, wherein updating the resource rank of the resource hosted at the service layer entity comprises at least one of:
determining, based on the occurrence of the one or more of the ranking events and the one or more rank values associated with the one or more of the ranking events, to increase the resource rank of the resource; and
determining, based on the occurrence of the one or more of the ranking events and the one or more rank values associated with the one or more of the ranking events, to decrease the resource rank of the resource.

10. The apparatus of claim 8, wherein the one or more ranking events comprise:
a resource discovery selection event;
a create, retrieve, update, or delete (CRUD) operation associated with the resource;
an update to a number of subscriptions and notification targets for the resource;
a determination that the resource has been announced; and
a response to a group fan-out operation of the resource.

11. The apparatus of claim 8, wherein the instructions, when executed, further cause the service layer entity to perform operations comprising generating a list of a plurality of resources hosted at the service layer entity based on a determined resource rank associated with each of the plurality of resources.

12. The apparatus of claim 11, wherein generating the list of the plurality of resources comprises weighting a first one of the ranking events different than a second one of the ranking events.

13. The apparatus of claim 8, wherein the instructions, when executed, further cause the service layer entity to perform operations comprising creating a resource ranking preference profile that indicates one or more preferences for ranking a resource hosted at the service layer entity.

14. The apparatus of claim 8, wherein the instructions, when executed, further cause the service layer entity to perform operations comprising sending, to an other service layer entity, an indication that the resource rank of the resource has been updated at the service layer entity, wherein the other service layer entity is configured to update a ranking profile stored at the other service layer entity based on the received indication.

15. A computer-readable storage medium storing instructions which, when executed by a processor of an apparatus, implement a service layer entity of a communications network and cause the service layer entity to perform operations comprising:
determining a ranking profile that indicates, for one or more resources, one or more ranking events and one or more rank values associated with the one or more ranking events;
receiving an indication of the occurrence of one or more of the ranking events; and
updating, based on the occurrence of the one or more of the ranking events, and based on one or more of the rank values associated with the one or more ranking events, a resource rank of a resource hosted at the service layer entity.

16. The computer-readable storage medium of claim 15, wherein updating the resource rank of the resource hosted at the service layer entity comprises at least one of:
determining, based on the occurrence of the one or more of the ranking events and the one or more rank values associated with the one or more of the ranking events, to increase the resource rank of the resource; and
determining, based on the occurrence of the one or more of the ranking events and the one or more rank values associated with the one or more of the ranking events, to decrease the resource rank of the resource.

17. The computer-readable storage medium of claim 15, wherein the one or more ranking events comprise:
a resource discovery selection event;
a create, retrieve, update, or delete (CRUD) operation associated with the resource;
an update to a number of subscriptions and notification targets for the resource;
a determination that the resource has been announced; and
a response to a group fan-out operation of the resource.

18. The computer-readable storage medium of claim 15, wherein the instructions, when executed, further cause the service layer entity to perform operations comprising generating a list of a plurality of resources hosted at the service layer entity based on a determined resource rank associated with each of the plurality of resources.

19. The computer-readable storage medium of claim 18, wherein generating the list of the plurality of resources comprises weighting a first one of the ranking events different than a second one of the ranking events.

20. The computer-readable storage medium of claim 15, wherein the instructions, when executed, further cause the service layer entity to perform operations comprising creating a resource ranking preference profile that indicates one or more preferences for ranking a resource hosted at the service layer entity.
